(19) United States
(12) Patent Application Publication
(10) Pub. No.: US 2018/0092048 A1
(43) Pub. Date: Mar. 29, 2018

(54) TRANSMIT POWER GAIN CALIBRATION AND COMPENSATION

(71) Applicant: QUALCOMM Incorporated, San Diego, CA (US)

(72) Inventors: Hao-Jen Cheng, San Jose, CA (US); Kapil Rai, Sunnyvale, CA (US); Chih-Yuan Chu, Hsinchu City (TW); Wen-Chang Yeh, Hsinchu City (TW)

(21) Appl. No.: 15/275,305

(22) Filed: Sep. 23, 2016

(51) Int. Cl. H04W 52/34; H04B 17/318; H04W 24/02

(52) U.S. Cl. CPC H04W 52/34; H04W 24/02; H04B 17/318

(57) ABSTRACT

Methods, systems, and devices for wireless communication are described. A wireless device may transmit a first calibration packet at a first power level. The wireless device may determine a power measurement corresponding to the first calibration packet based at least in part on feedback associated with a transmit power output of the first calibration packet. The wireless device may compare the power measurement corresponding to the first calibration packet to a target power level associated with the first power level. Additionally, the wireless device may adjust one or more gain parameters associated with the first power level based at least in part on the comparing.

### BACKGROUND

The following relates generally to wireless communication, and more specifically to providing techniques for calibrating transmit power gain and compensating transmit power for changed transmission or operational conditions.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via a downlink (DL) and an uplink (UL) transmission path. The DL (or forward link) may refer to the communication link from the AP to the STA, and the UL (or reverse link) may refer to the communication link from the STA to the AP.

WLAN transceivers (e.g., such as those used in an AP or STA) may employ a transmit power calibration scheme (e.g., a closed loop power control (CLPC) or open loop power control (OLPC) scheme) to ensure transmit power compliance with regulatory agencies and/or proper transmission to meet performance requirements. A typical hardware-based CLPC or OLPC engine after a transmit power calibration process may work autonomously by selecting transmission gain parameters based on a particular transmit power requirement. Thereafter, error signals are typically received by the AP from one or more far-end receiving devices, and the identified error rates may be used to adjust the transmission gain parameters. In the past, this ‘best effort’ approach of transmit power compensation by adjusting the transmission gain parameters based on these identified error rates was sufficient for transmission operations. It is, however, desirable to implement more precise and proactive transmit power calibration and compensation techniques for very-high throughput and multiple-input multiple output (MIMO) systems.

### SUMMARY

Systems, methods, and apparatus for providing transmit power gain calibration and compensation are described. In some examples, a wireless local area network (WLAN) transceiver (e.g., in an access point (AP), station (STA), or like wireless communication device) may transmit a calibration packet (e.g., a short packet that is different from a data packet) at a particular power level that corresponds to a data packet to be transmitted (e.g., a queued data packet that will be transmitted immediately or shortly after the calibration packet). The calibration packet may include an indication (e.g., one or more bits in a portion of the packet) that can be used by one or more components in a transmit feedback path to distinguish the calibration packet from a data packet. The WLAN transceiver may determine a power measurement corresponding to the transmitted calibration packet and may compare the power measurement to a target power level. The target power level may correspond to the particular power level at which the calibration packet was transmitted (e.g., the calibration packet being transmitted at a same power level as the target power level or a ½ dB more or less than the transmit power level). The WLAN transceiver may then adjust one or more gain parameters (e.g., one or more digital and/or analog gain parameters) associated with the particular power level. The particular power level may be provided by a transmit power gain configuration with reference to an associated transmit power gain index, both of which may include entries in one or more transmit power gain look-up tables (LUTs). The one or more transmit power gain LUTs may include one or more digital and/or analog gain parameters. The particular power level as provided by the transmit power gain configuration may be adjusted based at least in part on the comparing the power measurement corresponding to the transmitted calibration packet to the target power level.

In some examples, a WLAN device may transmit multiple calibration packets prior to transmitting the associated multiple data packets (e.g., during a multiple-input multiple output (MIMO) transmission involving a plurality of antennas). For example, a first WLAN transceiver may transmit a first calibration packet at a particular power level and a first frequency range, where the first frequency range is associated with a first frequency band or segment of a wireless channel. The first WLAN transceiver (or a second WLAN transceiver) may transmit a second calibration at the same particular power level, but at a second frequency range, where the second frequency range is associated with a second frequency band or segment of the wireless channel. These multiple frequency bands or segments may be contiguous segments with generally adjacent frequency bands or may be noncontiguous segments with a separation between frequency bands. Additionally, these multiple frequency bands or segments may be operated by different transmit chains of the first WLAN transceiver (and/or of the second WLAN transceiver) of the WLAN device. In some case, a transmit chain of the first WLAN transceiver can operate on both of these multiple frequency bands or segments and switch between multiple frequency bands or segments on a packet-per-packet basis.

In some examples, WLAN transceiver may select a transmit power gain configuration associated with a target power level of a data packet to be transmitted. The transmit power gain configuration may include multiple digital and analog gain parameters. For example, a first digital gain parameter may be associated with a first digital gain component, and a second digital gain parameter may be associated with a second digital gain component. An analog gain parameter of the transmit power gain configuration may be associated with an analog gain component. The WLAN transceiver may determine to adjust the transmit power gain configuration based at least in part on changed transmission or operational conditions (e.g., a type of the data packet to be transmitted, a type of transmission associated with the data packet to be transmitted, or a temperature measurement). In some cases, for example, to make a fine-tune adjustment of the transmit power gain configuration associated with a target power level, the WLAN transceiver may adjust the first digital gain parameter without adjusting the second digital gain parameter and the analog gain parameter.

An apparatus for wireless communication is described. The apparatus may include a processor, memory in electronic communication with the processor, and instructions stored in the memory. The instructions may be operable to cause the processor to transmit a first calibration packet at a first power level, the transmitting based at least in part on a first transmit power gain index associated with the first power level, determine a power measurement corresponding to the first calibration packet based at least in part feedback associated with a transmit power output of the first calibration packet, compare the power measurement corresponding to the first calibration packet to a target power level associated with the first power level, and adjust one or more gain parameters associated with the first power level based at least in part on the comparing.

A method of wireless communication is described. The method may include transmitting a first calibration packet at a first power level, the transmitting based at least in part on a first transmit power gain index associated with the first power level, determining a power measurement associated with the first calibration packet based at least in part on feedback associated with a transmit power output of the first calibration packet, comparing the power measurement corresponding to the first calibration packet to a target power level associated with the first power level, and adjusting one or more gain parameters associated with the first power level based at least in part on the comparing.

Another apparatus for wireless communication is described. The apparatus may include means for transmitting a first calibration packet at a first power level, the transmitting based at least in part on a first transmit power gain index associated with the first power level, means for determining a power measurement associated with the first calibration packet based at least in part on feedback associated with a transmit power output of the first calibration packet, means for comparing the power measurement corresponding to the first calibration packet to a target power level associated with the first power level, and means for adjusting one or more gain parameters associated with the first power level based at least in part on the comparing.

A non-transitory computer readable medium for wireless communication is described. The non-transitory computer-readable medium may include instructions operable to cause a processor to transmit a first calibration packet at a first power level, the transmitting based at least in part on a first transmit power gain index associated with the first power level, determine a power measurement corresponding to the first calibration packet based at least in part on feedback associated with a transmit power output of the first calibration packet, compare the power measurement corresponding to the first calibration packet to a target power level associated with the first power level, and adjust one or more gain parameters associated with the first power level based at least in part on the comparing.

In some examples of the method, apparatus, or non-transitory computer-readable medium described above, the adjusting one or more gain parameters comprises adjusting one or more digital gain parameters associated with the first transmit power gain index.

In some examples of the method, apparatus, or non-transitory computer-readable medium described above, the adjusting one or more gain parameters comprises selecting a set of digital and analog gain parameters associated with a second transmit power gain index, the second transmit power gain index different from the first transmit power gain index.

Some examples of the method, apparatus, or non-transitory computer-readable medium described above may further include processes, features, means, or instructions for delaying a transmission of a queued data packet until determining the power measurement corresponding to the first calibration packet, the queued data packet being associated with a pending transmission to be transmitted at the first power level.

In some examples of the method, apparatus, or non-transitory computer-readable medium described above, the first calibration packet comprises an indication that distinguishes the first calibration packet from a data packet. In some examples of the method, apparatus, or non-transitory computer-readable medium described above, the indication that distinguishes the first calibration packet comprises one or more bits set in a calibration field.

In some examples of the method, apparatus, or non-transitory computer-readable medium described above, the first calibration packet is shorter than a first scheduled data packet for transmission prior to the first calibration packet and is shorter than a second scheduled data packet for transmission after the first calibration packet.

In some examples of the method, apparatus, or non-transitory computer-readable medium described above, the transmitting a first calibration packet comprises: transmitting the first calibration packet based at least in part on an indication of a first temperature change.

Some examples of the method, apparatus, or non-transitory computer-readable medium described above may further include processes, features, means, or instructions for performing a transmit power gain calibration procedure based at least in part on an indication of a second temperature change, the second temperature change being different from the first temperature change.

Some examples of the method, apparatus, or non-transitory computer-readable medium described above may further include processes, features, means, or instructions for applying the one or more gain parameters associated with the first power level to a first transmit chain, and transmitting a first data packet via the first transmit chain.

In some examples of the method, apparatus, or non-transitory computer-readable medium described above, the transmitting a first calibration packet comprises transmitting the first calibration packet at a first frequency range.

Some examples of the method, apparatus, or non-transitory computer-readable medium described above may further include processes, features, means, or instructions for transmitting a second calibration packet at the first power level and at a second frequency range that is different from the first frequency range, the transmitting based at least in part on the first transmit power gain index associated with the first power level.

Some examples of the method, apparatus, or non-transitory computer-readable medium described above may further include processes, features, means, or instructions for determining a power measurement corresponding to the second calibration packet based at least in part on feedback associated with a transmit power output of the second calibration packet, comparing the power measurement corresponding to the second calibration packet to the target power level associated with the first power level, and adjusting the one or more gain parameters associated with the first power level based at least in part on the comparing the power measurement corresponding to the second calibration packet to the target power level.

Some examples of the method, apparatus, or non-transitory computer-readable medium described above may further include processes, features, means, or instructions for applying the one or more gain parameters associated with the first power level to a second transmit chain, and transmit a second data packet via the second transmit chain.

In some examples of the method, apparatus, or non-transitory computer-readable medium described above, the one or more gain parameters are associated with a transmit power gain index and a temperature at which the transmit power gain index was calibrated.

In additional examples, an apparatus for wireless communication is described. The apparatus may include a processor, memory in electronic communication with the processor, and instructions stored in the memory. The instructions may be operable to cause the processor to select a transmit power gain configuration associated with a target power level of a data packet to be transmitted, the transmit power gain configuration including a first digital gain parameter associated with a first digital gain component, a second digital gain parameter associated with a second digital gain component that is different from the first digital gain component, and an analog gain parameter associated with an analog gain component, determine to adjust the transmit power gain configuration based at least in part on changed transmission or operational conditions, and adjust the first digital gain parameter without adjusting the second digital gain parameter and the analog gain parameter.

A method of wireless communication is described. The method may include selecting a transmit power gain configuration associated with a target power level of a data packet to be transmitted, the transmit power gain configuration including a first digital gain parameter associated with a first digital gain component, a second digital gain parameter associated with a second digital gain component that is different from the first digital gain component, and an analog gain parameter associated with an analog gain component, determining to adjust the transmit power gain configuration based at least in part on changed transmission or operational conditions, and adjusting the first digital gain parameter without adjusting the second digital gain parameter and the analog gain parameter.

Another apparatus for wireless communication is described. The apparatus may include means for selecting a transmit power gain configuration associated with a target power level of a data packet to be transmitted, the transmit power gain configuration including a first digital gain parameter associated with a first digital gain component, a second digital gain parameter associated with a second digital gain component that is different from the first digital gain component, and an analog gain parameter associated with an analog gain component, means for determining to adjust the transmit power gain configuration based at least in part on changed transmission or operational conditions, and means for adjusting the first digital gain parameter without adjusting the second digital gain parameter and the analog gain parameter.

A non-transitory computer readable medium for wireless communication is described. The non-transitory computer-readable medium may include instructions operable to cause a processor to select a transmit power gain configuration associated with a target power level of a data packet to be transmitted, the transmit power gain configuration including a first digital gain parameter associated with a first digital gain component, a second digital gain parameter associated with a second digital gain component that is different from the first digital gain component, and an analog gain parameter associated with an analog gain component, determine to adjust the transmit power gain configuration based at least in part on changed transmission or operational conditions, and adjust the first digital gain parameter without adjusting the second digital gain parameter and the analog gain parameter.

Some examples of the method, apparatus, or non-transitory computer-readable medium described above may further include processes, features, means, or instructions for detecting a calibration packet among a plurality of data packets, measure a transmit power level associated with the calibration packet, and compare the measured transmit power level with the target power level.

In some examples of the method, apparatus, or non-transitory computer-readable medium described above, the first digital gain parameter is adjusted based at least in part on the comparing.

Some examples of the method, apparatus, or non-transitory computer-readable medium described above may further include processes, features, means, or instructions for determining a temperature associated with the transmit chain of the data packet to be transmitted, and identify an adjustment value for the first digital gain parameter based at least in part on the temperature.

In some examples of the method, apparatus, or non-transitory computer-readable medium described above, the first digital gain parameter is adjusted based at least in part on the identifying.

### BRIEF DESCRIPTION OF THE DRAWINGS

FIG. 1 illustrates an example of a system for wireless communication that supports providing transmit power gain calibration and compensation in accordance with aspects of the present disclosure;

FIG. 2 illustrates a illustrates a first example of wireless transceiver components of a wireless device for providing transmit power gain calibration and compensation in accordance with aspects of the present disclosure;

FIG. 3 illustrates a second illustrates a second example of wireless transceiver components of a wireless device for providing transmit power gain calibration and compensation in accordance with aspects of the present disclosure;

FIGS. 4 through 6 show block diagrams of a device that supports providing transmit power gain calibration and compensation in accordance with aspects of the present disclosure;

FIG. 7 illustrates a block diagram of a system including an AP that supports providing transmit power gain calibration and compensation in accordance with aspects of the present disclosure; and

FIGS. 8-12 illustrate methods for providing transmit power gain calibration and compensation in accordance with aspects of the present disclosure.

### DETAILED DESCRIPTION

Systems, methods, and apparatus for providing transmit power gain calibration and compensation over wireless local area network (WLAN) connections or channels are described herein. In some examples, a transmit power calibration procedure (e.g., associated with transmit power control (TPC) regulatory requirement or other power transmission considerations) may be used to identify, a priori, a set of transmit power gain requirements for achieving a respective set of transmit power targets that cover the transmission dynamic range associated with a WLAN transceiver (e.g., an entirety of the power and frequency ranges supported by the transmit chains of the WLAN transceiver). The set of transmit power gain requirements may be provided as look-up table (LUT) entries (or like transmit power gain configuration inputs) during a factory testing environment. Some or all of these transmit power gain LUT entries determined during factory testing (e.g., in a factory and/or during a factory test mode) may be stored and/or readily accessible as transmit power gain LUT entries (or like transmit power gain configurations). These transmit power gain LUT entries or configurations may then be utilized by a closed loop power control (CLPC) engine or open loop power control (OLPC) engine during transmission operations of the WLAN transceiver (e.g., mission mode).

During factory testing to determine the set of transmit power gain requirements, analog gain parameters (e.g. gain parameters associated with a radio frequency (RF) power amplifier and/or corresponding analog components) may be systematically adjusted to meet the maximum power levels for the respective set of transmit power targets (e.g. a transmit power gain index), while keeping the digital gain parameters (e.g., gain parameters associated with a digital-to-analog converter (DAC) and/or corresponding digital components) fixed. Additionally, factory testing may be performed at room temperature, and in some WLAN transceiver configuration and deployment scenarios, transmit power gain LUT entries may be characterized (e.g., the same golden bin values or parameters applied to multiple WLAN transceivers) instead of per-board (e.g., per-WLAN transceiver circuit board) calibrated. As such, variations based at least in part on temperature changes and/or per-board or WLAN transceiver circuits associated with the transmit power gain LUT entries or configurations may require transmit power gain compensation based at least in part on these (and other) changed transmission conditions (e.g., as applied during factory test mode and/or based on operational changes occurring during mission mode).

For example, the transmit power output associated with a packet transmitted may vary with the temperature of the transmitter or other components of the WLAN transceiver. These transmit power output variations due to temperature can be significant for data transmissions at high transmission rates and transmissions across a wide RF range (including disparate RF bands with different carrier frequencies). In some instances, a fixed temperature-based initial calibration performed during a factory testing environment can lead to transmission power errors of approximately +/−5 dB of transmit power gain variations during operation of the WLAN transceiver.

Aspects of the disclosure address transmitter gain issues caused by changed transmission or operational conditions such as, but not limited to, temperature variations of the WLAN transceiver and transmit gain spread across one or more RF bands. The techniques provided herein compensate for variations of transmit power gain LUT entries due to changed transmission or operational conditions for improving overall transmit power accuracy. For wider bandwidth modes (e.g., carrier aggregation or in noncontiguous 80+80-MHz mode of WLAN operation) including different bandwidth segments having different carrier frequencies, an optimized combination of transmit gain parameters for the different bandwidth segments is described for maximizing the transmit dynamic range, transmit power accuracy, and transmit signal quality. Thus, the techniques and approaches for calibrating transmit power gain and compensating transmit power described herein may provide higher throughput and better error vector magnitude (EVM) performance in wireless communication systems.

Aspects of the disclosure are initially described in the context of a wireless communications system. Non-limiting examples of WLAN transceivers and processes for using the WLAN transceivers to calibrate transmit power gains and compensate transmit power output for changed transmission or operational conditions are then described. Aspects of the present disclosure are further illustrated by and described with reference to apparatus diagrams, system diagrams, and flowcharts that relate to providing transmit power gain calibration and compensation.

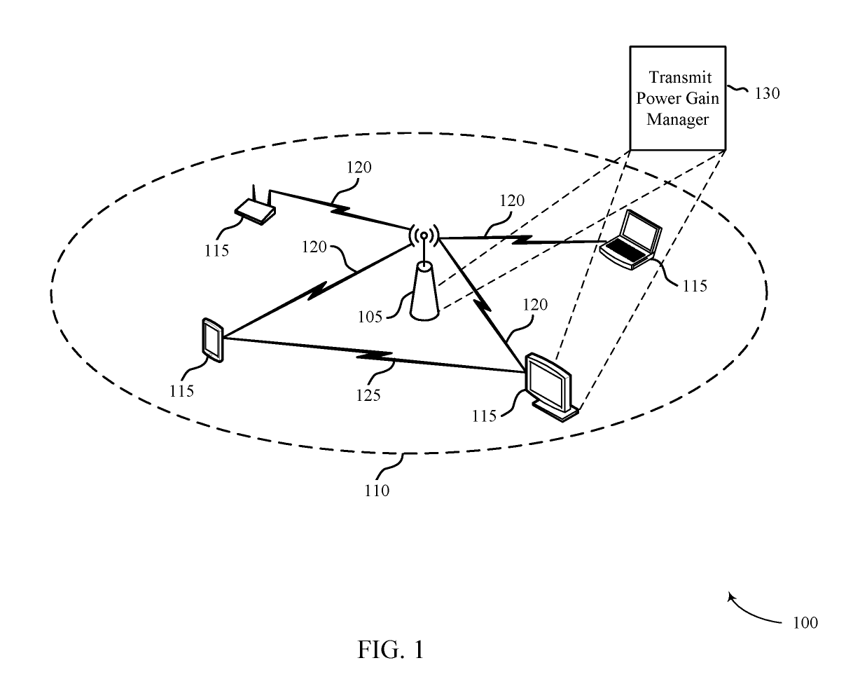

FIG. 1 illustrates a wireless network 100, which may be an example of a wireless local area network (WLAN) (also known as a Wi-Fi network). The wireless network 100 may include an AP 105 and multiple associated STAs 115, which may represent devices such as mobile stations, mobile phones, personal digital assistant (PDAs), other handheld devices, netbooks, notebook computers, tablet computers, laptops, display devices (e.g., TVs, computer monitors, etc.), printers, etc. The various STAs 115 in the wireless network 100 are able to communicate with one another through the AP 105 via wireless links 120. The various STAs 115 may also communicate with other STAs 115 via direct wireless links 125. Also shown is a coverage area 110 of the AP 105. In some examples, the wireless network 100 may generally be considered a non-3GPP network.

Although not shown in FIG. 1, a STA 115 may be located in the intersection of more than one coverage area 110 and may associate with more than one AP 105. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, etc. STAs 115 and APs 105 may communicate according to other radio access technologies (RATs).

Transmit power gain manager 130, as further described below, may manage transmit power gain calibration and transmit power output processes for AP 105 or STA 115, and the one or more wireless transceivers therein. For example, transmit power gain manager 130 may be used during mission mode to proactively apply transmit power gain adjustments for a target power level at which data packets are to be transmitted by AP 105 to STA 115 or transmitted by STA 115 to AP 105 or another STA 115.

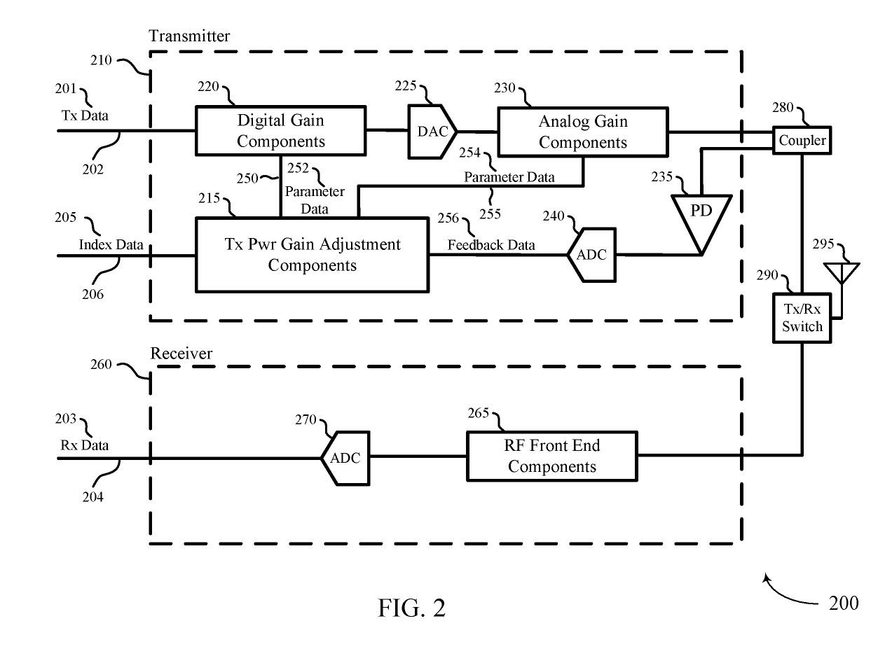

FIG. 2 illustrates a first example of wireless transceiver components of a wireless device 200 for providing transmit power gain calibration and compensation in accordance with aspects of the present disclosure. The wireless transceiver components of the wireless device 200 may be included on an AP, such as an AP 105 as described with reference to FIG. 1. In other examples, wireless transceiver components of the wireless device 200 may be included in a STA, such as the STA 115 described with reference to FIG. 1.

Wireless device 200 may include a transmitter 210 and a receiver 260. Transmitter 210 may acquire transmit data 201 from other components of the wireless device 200. The transmit data 201 may be provided via transmit data signal path 202 to one or more digital gain components 220 for performing various functions associated with the digital domain such as, but not limited to, transmit finite impulse response (FIR) filtering, digital signal processing, current or voltage scaling, and digital predistortion processing. Index data 205 (e.g., transmit power gain index) may be provided via index data signal path 206 to the one or more transmit power gain adjustment components 215. Index data 205 may be provided from various components of wireless device 200 (e.g., a transmit power gain manager and/or other components responsible for data transmission). Based at least in part on the index data 205, the one or more transmit power gain adjustment components 215 may provide an output of parameter data 252 (e.g., one or more digital gain parameters) to the one or more digital gain components 220 via digital gain signal path 250. In this manner, the one or more transmit power gain adjustment components 215 may control the one or more digital gain components 220. In some examples, the one or more transmit power gain adjustment components 215 may include components for determining or estimating transmit power errors and performing transmit power updates by interfacing with one or more transmit power gain LUTs. The one or more transmit power gain LUTs may provide configuration parameters and or values to various components of the transmitter 210.

The output of the one or more digital gain components 220 may be provided to DAC 225. DAC 225 converts filtered and processed digital signals of the transmit data to generate an analog signal. The analog signal may be provided to one or more analog gain components 230 for performing various functions associated with the analog domain such as, but not limited to, baseband filtering (e.g., low-pass, high-pass, and/or bandpass filtering), signal conversion, signal mixing, and power amplification. Based at least in part on the index data 205, the one or more transmit power gain adjustment components 215 may provide an output of parameter data 254 (e.g., one or more analog gain parameters) to the one or more analog gain components 230 via analog gain signal path 255. In this manner, the one or more transmit power gain adjustment components 215 may control the one or more analog gain components 230.

The output of the one or more analog gain components 230 may correspond to the transmit signal to be transmitted by the transmitter 210 and may be provided to coupler 280. Coupler 280 may provide the transmit signal to transmit-receive switch component 290 for transmission via one or more antennas 295. Coupler 280 may also provide the transmit signal to packet power detector 235 for measuring the transmit power of the transmit signal. The packet power detector 235 may also be configured to detect whether a packet is a calibration packet (e.g., to distinguish between live content data traffic packets and calibration packets when operating in mission mode). The output of the packet power detector 235 may be provided to a power-detect analog-to-digital converter (ADC) 240. Power-detect ADC 240 may convert an analog voltage (or, in some implementations, an analog current) to a digital signal representing the measured transmit power. Feedback data 256 may be provided as an output of the power-detect ADC 240 (e.g., a digital signal of the power-detect ADC 240 corresponding to a power output measurement) to be provided as an input to the one or more transmit power gain adjustment components 215. In this manner, the one or more transmit power gain adjustment components 215 can make any necessary gain adjustments (e.g., increase or decrease the transmit power output associated with a target power by modifying the one or more digital gain parameters associated with the one or more digital gain components 220, increase or decrease the transmit power output associated with a target power by selecting a different transmit power gain index that has the different digital and/or analog gain parameters associated with the one or more digital gain components 220 and/or the one or more analog gain components 230, etc.). In some cases, these gain adjustments can be made to a transmit power gain configuration (e.g., one or more gain parameters and an associated transmit power index that may be stored in one or more transmit power LUTs) based at least in part on the measured transmit power output. In some cases, these gain adjustments can be made by changing an association of a particular target power to a corresponding transmit power gain index of a transmit power gain configuration based at least in part on the measured transmit power output.

Receiver 260 may provide received data 203 to other components of the wireless device 200 via receive data signal path 204. Receiver 260 may include one or more RF front end components 265 that are operatively coupled to the transmit-receive switch component 290. The one or more RF front end components 265 may perform various functions associated with the analog domain such as, but not limited to, low power signal amplification (e.g., by using one or more low noise amplifiers), receive signal mixing, and receive baseband filtering. The one or more RF front end components 265 may be provided to an analog-to-digital converter (ADC) 270. ADC 270 converts an analog voltage (or, in some implementations, an analog current) to a digital signal. The digital signal of the received data 203 may be provided to other components of the wireless device 200 via receive data signal path 204.

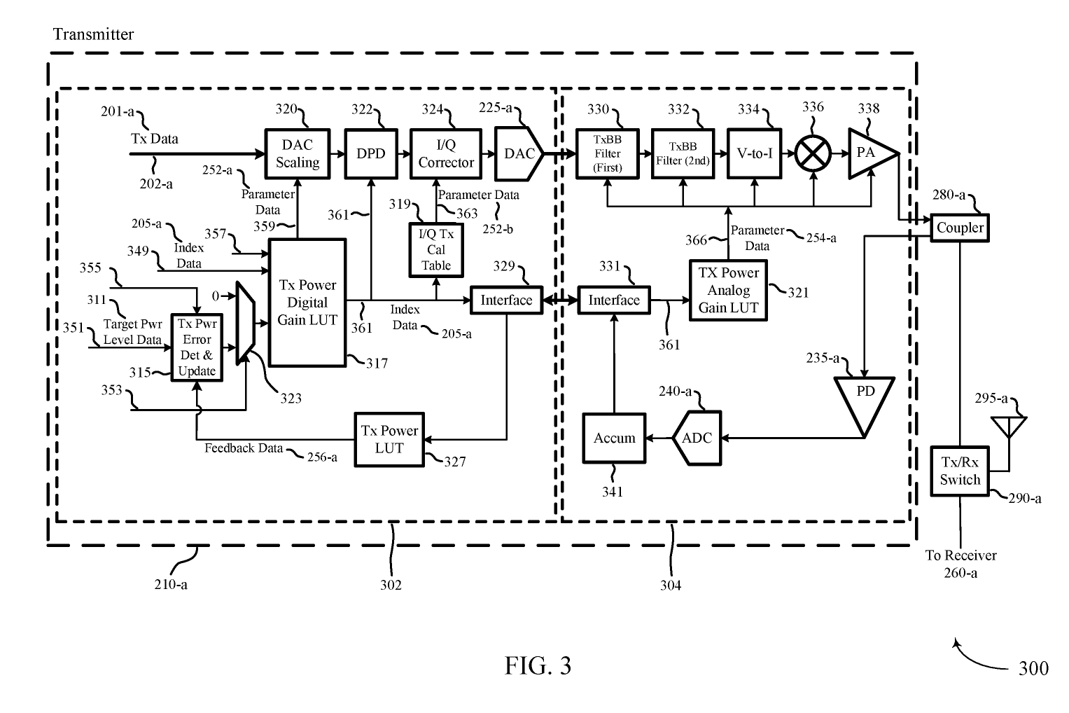

FIG. 3 illustrates a second example of wireless transceiver components of a wireless device 300 for providing transmit power gain calibration and compensation in accordance with aspects of the present disclosure. The wireless transceiver components of a wireless device 300 may be included on an AP, such as an AP 105 as described with reference to FIG. 1. In other examples, wireless transceiver components of a wireless device 300 may be included in a STA, such as the STA 115 described with reference to FIG. 1. In other examples, the wireless transceiver components of wireless device 300 may be included with and/or replace one or more wireless transceiver components of wireless device 200.

Transmitter 210-a may acquire transmit data 201-a from other components of the wireless device 300 (e.g., one or more components associated with a higher layer protocol such as the media access control (MAC) layer). In some cases, the transmit data 201-a is data associated with live content data traffic between wireless device 300 and another wireless device (e.g., during mission mode). In other cases, the transmit data 201-a may originate from within the transmitter 210-a or from other components of the wireless device 300 associated with administrative or control operations (e.g., PHY level control information for transmission to another wireless device). Transmit data 201-a may be provided to transmit data signal path 202-a for transmission by wireless device 300.

Transmitter 210-a may include a PHY subsystem 302 and an RF subsystem 304. The PHY subsystem 302 and the RF subsystem 304 may be provided in a single integrated circuit in some implementations of the wireless device 300, and, in other implementations of the wireless device 300, the PHY subsystem 302 and the RF subsystem 304 may each be provided in separate integrated circuits. In other examples, however, the components described herein with respect to the PHY subsystem 302 and the RF subsystem 304 are not necessarily delineated with respect to a particular subsystem.

Additionally, the transmitter 210-a and component thereof may be operatively coupled to stand-alone components (e.g., printed circuit board (PCB) components or mechanically-mounted components) such as, but not limited to, coupler 280-a, transmit-receive switch component 290-a, and one or more antennas 295-a of the wireless device 300. Inconsistencies or imperfections concerning the interaction and/or arrangement between the one or more integrated circuits and the stand-alone components during the manufacturing process may result in various operational discrepancies between manufactured devices such as wireless device 300 and similar devices. The operational discrepancies among the manufactured wireless devices may become exacerbated when ‘per-board’ calibration processes are not implemented on each such device.

In addition to operational discrepancies associated with manufacturing, changed transmission conditions (e.g., temperature of components during transmission, transmission standards of packets being transmitted, center frequency and bandwidth associated with the packets being transmitted, etc.) may have a dynamic effect on the actual transmit power output achieved during transmission of a packet. Various examples of transmit power gain calibration and compensation techniques are provided with respect to wireless device 300 of FIG. 3. These techniques provide for transmitting various data rates (e.g., as specified in IEEE 802.11ac and other very high throughput system) in accordance with their respective EVM requirements for successful demodulation at a receiving wireless device. As such, the transmit power output of wireless device 300 may be controlled to ensure that a required EVM is met and emission mask regulatory requirements are satisfied.

PHY subsystem 302 may include a transmit power error determination and update component 315 and a transmit power digital gain LUT 317 for setting and adjusting one or more digital gain parameters. The transmit power error determination and update component 315 may include a target power input signal path 351 with which to receive target power level data 311. The target power level data 311 may correspond to an overall desired or commanded power output at which a packet is to be transmitted. The target power level data 311 may be associated with a transmit power gain index 205-a for which various components of the transmitter 210-a may reference to ascertain other gain parameters (e.g., settings, factors, values, or the like). For example, there may be a limited number of transmit power gain indexes 205-a and associated gain parameters for providing a transmit power output, and the wireless device 300 may select a particular transmit power gain index 205-a to match the desired transmit power level.

The transmit power digital gain LUT 317 may include a plurality of entries that represent at least a portion of the transmit power gain parameters corresponding to a plurality of transmit power gain indexes 205-a. In some cases, the transmit power digital gain LUT 317 may be configured with fewer transmit gain indexes 205-a than that of a typical WLAN transceiver to avoid the additional parameter permutations associated with the various digital and analog components of the transmitter 210-a and provided by other related LUTs such as but not limited to those described herein. For example, each entry of the transmit power digital gain LUT 317 may include a transmit power gain index 205-a, an upper power limit associated with that particular transmit power gain index 205-a, and one or more digital gain parameters associated with that particular transmit power gain index 205-a. Transmit power gain index 205-a values may cover a range of transmit powers for which the transmitter 210-a is designed to operate. In some implementations, transmit power gain index 205-a values may be range from 0 dBm to 20 dBm. Each entry may include a temperature value at which the transmit power gain index 205-a was initially calibrated to determine the associated gain parameters. Additionally or alternatively, each entry may include a temperature value at which the transmit power gain index 205-a was most recently calibrated to determine the associated gain parameters.

TABLE 1
Non-Limiting Example of Transmit Power
Digital Gain LUT Information

| Transmit Power | Upper Transmit | Digital Gain | Temperature |
|---|---|---|---|
| Gain Index | Power | Parameter(s) | (Optional) |
| 0 dBm | 1.8 dBm | Digital_gain- | 65 deg. F. |
| | | parameter_1 | |
| . . . | . . . | . . . | . . . |
| 20 dBm | 21.5 dBm | Digital_gain- | 87 deg. F. |
| | | parameter_2 | |

In the example of Table 1 above, factory testing transmit power digital gain LUT 317 may have occurred at 65 degrees Fahrenheit, but an digital gain parameters were updated based on a temperature reading of 87 degrees Fahrenheit. The transmit power digital gain LUT 317 may be initially populated with entries via an initial transmit power gain configuration input signal path 357. In operation, the transmit power digital gain LUT 317 may receive as the transmit power gain index 205-a as an input via transmit power gain index input signal path 349. The transmit power gain index 205-a that is provided as an input corresponds to the target power at which a particular packet (e.g., corresponding to transmit data 201-a) is to be transmitted by the wireless device 300.

The transmit power error determination and update component 315 may include a sensor input signal path 355 with which to receive sensor readings. For example, a thermal sensor (not shown) may be operatively coupled to sensor input signal path 355 such that a current temperature may be determined for transmitter 210-a (and/or other components) and applied in error correction operations by the transmit power error determination and update component 315. Error correction operations may include, but are not limited to, (i) comparing a current temperature value to an initial temperature value associated with a transmit power gain index 205-a whether to adjust the one or more digital gain parameters (e.g., when a temperature change is insignificant, ceasing error correction operations, and when a temperature change is small but sufficient enough to warrant fine-tune adjustment based at least in part on factory testing results, empirical data, or the like), (ii) comparing a current temperature value to an initial temperature value associated with a transmit power gain index 205-a whether to adjust the one or more digital and/or analog gain parameters by selecting a different transmit power gain index 205-a (e.g., when a temperature change or measured power difference based at least in part on the temperature change and/or frequency change is large enough, for instance, resulting in a 3 dB to 5 dB gain discrepancy, so as to warrant a different transmit power gain index 205-a and different digital and/or analog gain parameters, so as not to saturate the digital signal by applying too high of a digital gain and not to subject the digital signal to analog noise by applying too low of a digital gain), (iii) comparing a current temperature value to an initial temperature value associated with a transmit power gain index 205-a (e.g., upon entering mission mode) to determine whether to perform a transmit power gain calibration procedure that includes temporarily delaying or stopping data traffic to transmit a plurality of calibration packets (e.g., when a temperature change is large enough to warrant significant recalibration for instance, resulting in a 5 dB or greater gain discrepancy, where the temperature change corresponding to the gain discrepancy is based at least in part on factory testing results, empirical data, or the like), and (iv) enter a temperature value into the transmit power digital gain LUT 317 for association with a transmit power gain index 205-a.

The output of the transmit power error determination and update component 315 may be input to a selector 323. Selector 323 may determine whether to pass the output of the transmit power error determination and update component 315 to the transmit power digital gain LUT 317 or to null the output (i.e., not send or pass the output). Error update signal path 353 may provide an input to selector 323 for making the determination whether to pass the output of the transmit power error determination and update component 315 to the transmit power digital gain LUT 317 or to null the output. Error update signal path 353 may include a signal based at least in part on a type of the data packet to be transmitted (e.g., based on the standard or specification for which the data packet is formatted). For example, if a packet to be transmitted is a Bluetooth packet transmitted in accordance with the IEEE 802.15.1 or Bluetooth SIG standards, the signal provided to selector 323 via the error update signal path 353 may indicate to null the output of the transmit power error determination and update component 315. If, however, a packet to be transmitted is a packet transmitted in accordance with the IEEE 802.11ac standard, the signal provided to selector 323 via the error update signal path 353 may indicate to pass the output of the transmit power error determination and update component 315 to the transmit power digital gain LUT 317.

Additionally or alternatively, error update signal path 353 may include a signal based at least in part on a type of transmission associated with the data packet to be transmitted (e.g., based at least in part on whether the data packet to be transmitted is associated with an MU-MIMO transmission). For example, if the data packet to be transmitted is associated with an MU-MIMO or single-user (SU) MIMO transmission, the signal provided to selector 323 via the error update signal path 353 may indicate to pass the output of the transmit power error determination and update component 315 to the transmit power digital gain LUT 317. If, however, the data packet to be transmitted is associated with an SU transmission and/or below a predetermined data rate, the signal provided to selector 323 via the error update signal path 353 may indicate to null the output of the transmit power error determination and update component 315.

The transmit power digital gain LUT 317 may interface with other components of the PHY subsystem 302 such as a DAC scaling network 320, digital predistortion circuit 322, in-phase/quadrature phase (I/Q) transmit calibration table component 319, I/Q corrector 324, and PHY interface 329. DAC scaling network 320 may be based a R-2R ladder DAC design or a current scaling DAC design. For example, the digital gain associated with DAC scaling network 320 and the digital gain associated with the digital-to-analog conversion process in general may adjusted by changing the reference voltage associated with the DAC scaling network. For a particular transmit power gain index 205-a, the transmit power digital gain LUT 317 may provide digital parameter data 252-a to DAC scaling network 320 via DAC scaling digital gain signal path 359. The digital parameter data 252-a to DAC scaling network 320 may correspond to a predefined reference voltage or another parameter designated for adjusting the digital gain a DAC scaling network 320.

Digital predistortion circuit 322 may provide circuitry for operating amplifiers efficiently while improving linearity and minimizing spurious emissions. For example, the digital predistortion circuit 322 may alter a digital signal before it is amplified in a manner that counteracts an amplifier's non-linear distortion so as to produce a clearer output signal. For a particular transmit power gain index 205-a, the transmit power digital gain LUT 317 may provide the transmit power gain index 205-a itself representing the overall desired or commanded output power to digital predistortion circuit 322 via transmit power gain index signal path 361. Digital predistortion circuit 322 may then provide digital parameters associated with its circuitry operations based at least in part on the transmit power gain index 205-a.

It is to be understood that, although both the DAC scaling network 320 and the digital predistortion circuit 322 are digital domain components, the parameters (e.g., digital parameter data 252-a) for changing the DAC scaling network 320 and corresponding digital gain associated with the digital-to-analog conversion process may be permitted to change on a per-packet basis for transmit power control, whereas the parameters for changing the digital predistortion circuit 322 should remain constant for transmit power control for at least a digital predistortion training cycle. That is, digital pre-distortion techniques generally require a set of transmit analog or RF gain parameters to remain constant for a longer time period than a set of transmit digital gain parameters (e.g., parameters for changing the digital gain associated with DAC scaling network 320). The transmit dynamic range supported by digital predistortion circuit 322 may be covered by the set of transmit analog or RF gain parameters.

The I/Q transmit calibration table component 319 can provide digital parameter data 252-b (e.g., predetermined digital parameters associated with I/Q correction operations) via the I/Q corrector signal path 363 to the I/Q corrector 324 based at least in part on the transmit power gain index 205-a that is passed to the I/Q transmit calibration table component 319 from the transmit power digital gain LUT 317 via transmit power gain index signal path 361. The I/Q transmit calibration table component 319 may then provide the predetermined parameters to the I/Q corrector 324 based at least in part on the particular transmit power gain index 205-a. The I/Q corrector 324 may be used to pre-correct the in-phase (I) and quadrature-phase (Q) components of the transmit data for any IQ imbalance or distortion in the analog components and provide these in-phase (I) and quadrature-phase (Q) components to DAC 225-a. The DAC 225-a may then provide an analog signal corresponding to the transmit data to the RF subsystem 304.

The transmit power digital gain LUT 317 may also interface with PHY interface 329 for sending the transmit power gain index 205-a to the RF subsystem 304 and components thereof. In some cases, the entries of transmit power digital gain LUT 317 may modified by the transmit power error determination and update component 315 through selector 323. For example, one or more digital gain parameters associated with a particular transmit power gain index 205-a may be modified such that the digital gain associated with one or more digital components is adjusted while the one or more analog gain parameters associated with that particular transmit power gain index 205-a remain the same.

PHY subsystem 302 may also include a transmit power LUT 327 for determining an actual transmit power output based at least in part on measurements made by the RF subsystem 304 that are forwarded by the PHY interface 329 (e.g., via a bidirectional link with RF interface 331) to the transmit power LUT 327. The transmit power LUT 327 may then forward feedback data 256-a (e.g., the measured transmit power output) to the transmit power error determination and update component 315. In some examples, the contents of the transmit power LUT 327 may include a correlation between the output of the packet power detector 235-a that corresponds to the actual power output of the power amplifier 338 and that is used in determining the measured transmit output power. In some cases, the values for the transmit power LUT 327 may be derived by calibrating a response of the coupler 280-a and packet power detector 235-a on a per-device basis during a factory testing environment. In other cases, the values for the transmit power LUT 327 may be derived without factory testing (e.g., the values for the transmit power LUT 327 may be initially populated based at least in part on a golden bin golden bin values or parameters).

RF subsystem 304 may include a transmit power analog gain LUT 321 and an RF interface 331 that communicates bidirectional with the PHY interface 329. The transmit power analog gain LUT 321 may output analog parameter data 254-a (e.g., to set or adjust one or more analog gain parameters) via analog gain signal path 366. For example, the transmit power analog gain LUT 321 may receive as an input the transmit power gain index 205-a via transmit power gain index signal path 361 (i.e., the transmit power gain index 205-a that was forwarded from the transmit power digital gain LUT 317). Based at least in part on the transmit power gain index 205-a, the transmit power analog gain LUT 321 may output the analog parameter data 254-a via analog gain signal path 366 to one or more of first transmit baseband filter 330 and second transmit baseband filter 332, voltage-to-current converter 334, RF mixer 336, and power amplifier 338. In this manner, the transmit power analog gain LUT 321 may interface with other components of the RF subsystem 304 such as the first transmit baseband filter 330 and second transmit baseband filter 332, voltage-to-current converter 334, RF mixer 336, and power amplifier 338.

The analog signal corresponding to the transmit data that is output from DAC 225-a may be passed through two low pass baseband filters (e.g., to remove sampling artifacts) prior to providing the analog signal to the RF mixer 336. For example, the first transmit baseband filter 330 may provide a first gain or n₁ dB per octave power decrease at the cutoff frequency and the second transmit baseband filter 332 may provide a second gain or n₂ dB per octave power decrease at the cutoff frequency. The voltage-to-current converter 334 may receive a voltage-mode analog signal from the second transmit baseband filter 332 and converts the analog signal to a current differential so that the RF mixer 336 can perform a switching function in the current domain. The output of the RF mixer 336 is then passed to the power amplifier 338, which may be controlled by the one or more analog gain parameters provided by the transmit power analog gain LUT 321 via analog gain signal path 366.

The output of the power amplifier 338 may be passed to coupler 280-a. Coupler 280-a may pass the transmit signal to the transmit-receive switch component 290-a. Transmit-receive switch component 290-a may pass the transmit signal via one or more antennas 295-a for transmission to one or more receiving wireless devices. The transmit-receive switch component 290-a may also receive signals from receiver 260-a.

Coupler 280-a may also provide the transmit signal to packet power detector 235-a for measuring the transmit power of the transmit signal. The packet power detector 235-a may also be configured to detect whether a packet is a calibration packet (e.g., to distinguish between live content data traffic packets and calibration packets when operation in mission mode). In some cases, the indication that distinguishes the first calibration packet from data packets being transmitted during live traffic transmission operations (e.g., mission mode) can be one or more bits set in a portion of a calibration packet. For example, a single bit in the packet descriptor (e.g., ACX_PHY_DESC.tpc_glut_self_cal) can be used to indicate to packet power detector 235-a that the packet for which the power is being measured is a calibration packet. In some cases, one or more other components of the transmit feedback path (e.g., downstream digital components) may be configured to detect or distinguish whether a packet is a calibration packet.

The output of the packet power detector 235-a may be provided to a power-detect ADC 240-a. Power-detect ADC 240 may convert an analog voltage to a digital signal representing the measured transmit power. The digital signal of the power-detect ADC 240 may then be provided to accumulator 341, which may obtain one or more power measurements from one or more packets during a calibration procedure and forward an accumulated digital signal to RF interface 331.

For example, when transmitter 210-a is operating in the factory test mode, the accumulator 341 may obtain a plurality of power measurements from a plurality of packets, each of which may be transmitted with the same target power level. When transmitter 210-a is operating in the mission mode and has initiated a transmit power gain calibration procedure (e.g., based at least in part on an indication of large temperature change or other indication that a significant calibration reset is warranted), the accumulator 341 may likewise obtain a plurality of power measurements from a plurality of packets, each of which may be transmitted with the same target power level. However, when transmitter 210-a is operating in the mission mode and receives an indication that that a calibration packet is being measured while live data traffic packets are also being transmitted by the transmitter 210-a, the accumulator 341 may obtain the power measurement from that calibration packet.

The RF interface 331 may provide the accumulated digital signal to the PHY interface 329 of the PHY subsystem 302 for further processing and evaluation of the corresponding one or more power measurements. It is to be understood that transmitter 210-a is a non-limiting transmitter architecture example and that other transmitter architectures for calibrating transmit power gain and compensating transmit power may be used given the benefit of the present disclosure.

In an example of the transmit power calibration and transmit power compensation techniques of the present disclosure, wireless device 300 may determine to transmit a high throughput data packet. For example, the high throughput data packet may be transmitted in accordance with the IEEE 802.11ac standard, which included 80 MHz channels. Additionally, the IEEE 802.11ac standard allows for a 160 MHz channel to be either a single contiguous block or two noncontiguous 80 MHz channels (i.e., using two different frequency bands or ranges). The wireless device 300 may determine to transmit the high throughput data packet as part of a MU-MIMO transmission. Based at least in part on this data packet being transmitted in accordance with the IEEE 802.11ac, this data packet being transmitted part of a MU-MIMO transmission, and/or detection of a temperature change associated with the transmitter 210-a, the wireless device 300 may determine to transmit a calibration packet. In some cases, the calibration may be a short (e.g., 20 μs) OFDM calibration packet with specific target power level and a full transmitter chain power spectrum emission mask. The calibration packet may include an indicator that that the calibration packet is associated with a self-calibration process (e.g., a transmit power adjustment process associated with the transmit power digital gain LUT 317).

Transmitting this calibration packet prior to the high throughput data may be advantageous for at least the reason that as performance and throughput expectations increase, particularly with respect to MU-MIMO transmission techniques, even minor transmission degradations (e.g., a transmission power loss of only a few dB) can cause significant errors in high throughput performance. Thus, for wider bandwidth modes (e.g., carrier aggregation) including different bandwidth segments having different carrier frequencies, an optimized combination of transmit power digital gain parameters for the different bandwidth segments may be determined thereby maximizing the transmit dynamic range, TPC accuracy, and/or transmit signal quality. In this regard, the transmission of the high throughput data packet in queue is delayed until a determination of a power measurement associated with the transmitted calibration packet power is obtained.

The wireless device 300 may transmit the calibration packet while operating in the mission mode (e.g., when live content data traffic packets data traffic packets are also being transmitted to one or more receiving wireless devices). Wireless device 300 may determine that the calibration packet is to be transmitted at a 15 dBm power level, which correspond to the target power level for the high throughput data packet. The wireless device 300 may include a transmit power gain configuration associated with the transmit power gain index 205-a of 15 dBm. This transmit power gain configuration may have corresponding entries in one or more of the transmit power digital gain LUT 317, I/Q transmit calibration table component 319, transmit power analog gain LUT 321, and transmit power LUT 327.

The calibration packet may be provided to transmit data signal path 202-a for transmission by the transmitter 210-a (e.g., transmission through at least the PHY subsystem 302, RF subsystem 304, and coupler 280-a). The target power level of 15 dBm may be provided to the transmit power error determination and update component 315 via the target power input signal path 351. In this example, error update signal path 353 may provide an input to selector 323 indicating to pass the output of the transmit power error determination and update component 315 to the transmit power digital gain LUT 317. The transmit power digital gain LUT 317 may identify an entry for a transmit power gain index 205-a of 15 dBm that includes one or more digital parameters associated with one or more digital components and an upper transmit power of 18.7 dBm.

The transmit power digital gain LUT 317 may provide digital parameter data 252-a one or more digital parameters associated with the DAC scaling network 320 that correspond to the transmit power gain index 205-a of 15 dBm via DAC scaling digital gain signal path 359. The transmit power digital gain LUT 317 may pass the transmit power gain index 205-a of 15 dBm to digital predistortion circuit 322 via transmit power gain index signal path 361. The transmit power digital gain LUT 317 may also pass the transmit power gain index 205-a of 15 dBm to I/Q transmit calibration table component 319 via transmit power gain index signal path 361. I/Q transmit calibration table component 319 may then provide digital parameter data 252-b via the I/Q corrector signal path 363 to the I/Q corrector 324 via based at least in part on the transmit power gain index 205-a of 15 dBm.

The transmit power digital gain LUT 317 may pass the transmit power gain index 205-a of 15 dBm to PHY interface 329 via transmit power gain index signal path 361. PHY interface 329 may then pass the transmit power gain index 205-a of 15 dBm to RF interface 331, which may then pass the transmit power gain index 205-a of 15 dBm to transmit power analog gain LUT 321 via transmit power gain index signal path 361. Based at least in part on the transmit power gain index 205-a of 15 dBm, the transmit power analog gain LUT 321 may output the analog parameter data 254-a via analog gain signal path 366 (e.g., one or more analog gain parameters) to the transmit baseband filter 330, 332, voltage-to-current converter 334, RF mixer 336, and power amplifier 338 via analog gain signal path 366.

As such, the transmit chain of transmitter 210-a may be configured to transmit the calibration packet at 15 dBm. The power amplifier 338 provides the transmit signal of the calibration packet to coupler 280-a, which then passes the transmit signal to packet power detector 235-a. The packet power detector 235-a may be configured to detect that the packet is indeed a calibration packet. The output of the packet power detector 235-a may be provided to a power-detect ADC 240-a, which may convert an analog voltage to a digital signal representing the measured transmit power of the calibration packet. The digital signal of the power-detect ADC 240 may then be provided to accumulator 341, which may clear registers associated with other power measurements from one or more packets during a prior calibration procedure and store the power measurement associated with the calibration packet. For example, the calibration registers may include information concerning a transmit power calibration status (e.g., Tpc_self_cal_status register, where 0 equals not done, 1 equals successfully completed, and 2 equals failure). The calibration registers may include information concerning a transmit power measured power (e.g., tpc_self_cal meas_pwr register), information concerning a calibration closed loop power control error (e.g., tpc_self_cal_clpc_err register), and information concerning the calibration packet target packet (e.g., tpc_self_cal_target_pwr register).

The accumulator 341 may forward the digital signal of the calibration packet to RF interface 331. The RF interface 331 may provide the accumulated digital signal to the PHY interface 329 of the PHY subsystem 302 for further processing and evaluation of the corresponding power measurement of the calibration packet. The transmit power LUT 327 may determine that the actual transmit power output associated with the calibration packet based at least in part on this measurement. For example, the transmit power LUT 327 may determine that the actual transmit power output associated with the calibration packet is 12 dBm and may forward feedback data 256-a (e.g., the measured transmit power output of 12 dBm) to the transmit power error determination and update component 315.

This calibration packet information may be provided to the transmit power error determination and update component 315, which may compare the power measurement associated with the calibration packet to the target power level. The transmit power error determination and update component 315 may determines to make a 3 dB gain adjustment to the one or more digital parameters associated with the DAC scaling network 320 that correspond to the transmit power gain index 205-a of 15 dBm. The transmit power error determination and update component 315 may forward these adjusted one or more digital parameters to the transmit power digital gain LUT 317 to replace the previous parameters one or more digital parameters associated with the transmit power gain index 205-a of 15 dBm.

When the wireless device 300 determines to transmit the high throughput data packet associated with this measured calibration packet, the high throughput data packet may be transmitted with the adjusted one or more digital parameters to the transmit power digital gain LUT 317. For example, the transmit power digital gain LUT 317 may provide the adjusted one or more digital parameters (e.g., digital parameter data 252-a) associated with the DAC scaling network 320 that correspond to the transmit power gain index 205-a of 15 dBm via DAC scaling digital gain signal path 359, while passing the same transmit power gain index 205-a of 15 dBm to digital predistortion circuit 322 via transmit power gain index signal path 361. Similarly, the transmit power digital gain LUT 317 may pass the same transmit power gain index 205-a of 15 dBm to I/Q transmit calibration table component 319 via transmit power gain index signal path 361. I/Q transmit calibration table component 319 may then provide the same digital parameter data 252-b via the I/Q corrector signal path 363 to the I/Q corrector 324 based at least in part on the transmit power gain index 205-a of 15 dBm.

The transmit power digital gain LUT 317 may pass the transmit power gain index 205-a of 15 dBm to PHY interface 329 via transmit power gain index signal path 361. PHY interface 329 may pass the transmit power gain index 205-a of 15 dBm to RF interface 331, which may then pass the transmit power gain index 205-a of 15 dBm to transmit power analog gain LUT 321 via transmit power gain index signal path 361. Based at least in part on the transmit power gain index 205-a of 15 dBm, the transmit power analog gain LUT 321 may output the corresponding analog parameter data 254-a via analog gain signal path 366 to the transmit baseband filter 330, 332, voltage-to-current converter 334, RF mixer 336, and power amplifier 338 via analog gain signal path 366.

As adjusted in accordance with the calibration packet process, the transmit chain of transmitter 210-a may be configured to transmit the high throughput data packet at 15 dBm with the adjustments made to the one or more digital parameters (and/or to the one or more analog parameters in some cases). The power amplifier 338 provides the transmit signal of the high throughput data packet to coupler 280-a, which provides this transmit signal of the high throughput data packet to the transmit-receive switch component 290-a. Transmit-receive switch component 290-a may pass the transmit signal of the high throughput data packet via one or more antennas 295-a for transmission to one or more receiving wireless devices.

Additional examples of transmit power calibration and transmit power compensation techniques may be readily understood with the benefit of this calibration packet and high throughput data packet example in conjunction with other aspects of the present disclosure. For example, calibration packets may be transmitted in each of a plurality of transmit chains of transmitter 210-a that are part of an MU-MIMO transmission using bandwidth segments having a different frequencies.

In some examples, the variation of the transmit power gain index 205-a as compared to temperature changes may be characterized during factory testing environments such that transmit power gain index vs. temperature curves may be obtained for various temperature-related process operations. As described herein, certain transmit power calibration and transmit power compensation techniques may utilize an appropriate transmit power gain index vs. temperature curves to determine temperature abscissae at which the transmit power gain variation (e.g., an overall increase or decrease of transmit power output) would have deviated by more than half the permissible CLPC error range.

Calibration and adjustment decisions may be made based at least in part on the information from these temperature curves. For example, in the mission mode, a transmit power gain calibration procedure may be performed when the temperature changes by an amount greater than the separation between the abscissae from the temperature at which the previous transmit power gain calibration procedure was performed (e.g., the temperature change is determined to be significant).

In yet another example, the transmission of calibration packet during mission mode may be avoided in some instances and the transmit power digital gain LUT 317 may be adjusted for temperature variation by using a thermal sensor (not shown) that is operatively coupled to the sensor input signal path 355. A transmit power gain for every transmit chain or segment may be calibrated (e.g., using the calibration packet process described herein) in the factory testing environment. This temperature-based factory mode calibration process should be performed before at least some of the calibration processes associated with the one or more digital components (e.g., digital predistortion circuit 322, I/Q transmit calibration table component 319, and I/Q corrector 324) are performed. A current temperature of the transmitter 210-a (and/or other components) can be determined and applied in error correction operations by the transmit power error determination and update component 315. An amount of transmit power digital gain can be adjusted to a particular transmit power gain index 205-a based at least in part on the thermal sensor readings (e.g., transmit power digital gain delta=thermal_alpha*(thermal_new−thermal_measurement), where thermal_alpha is approximately − 1/15 to − 1/20 (dB/degC), thermal_new is the current or most recent thermal measurement (in degC), and thermal_measurement is the baseline measurement(s) made during factory test mode).

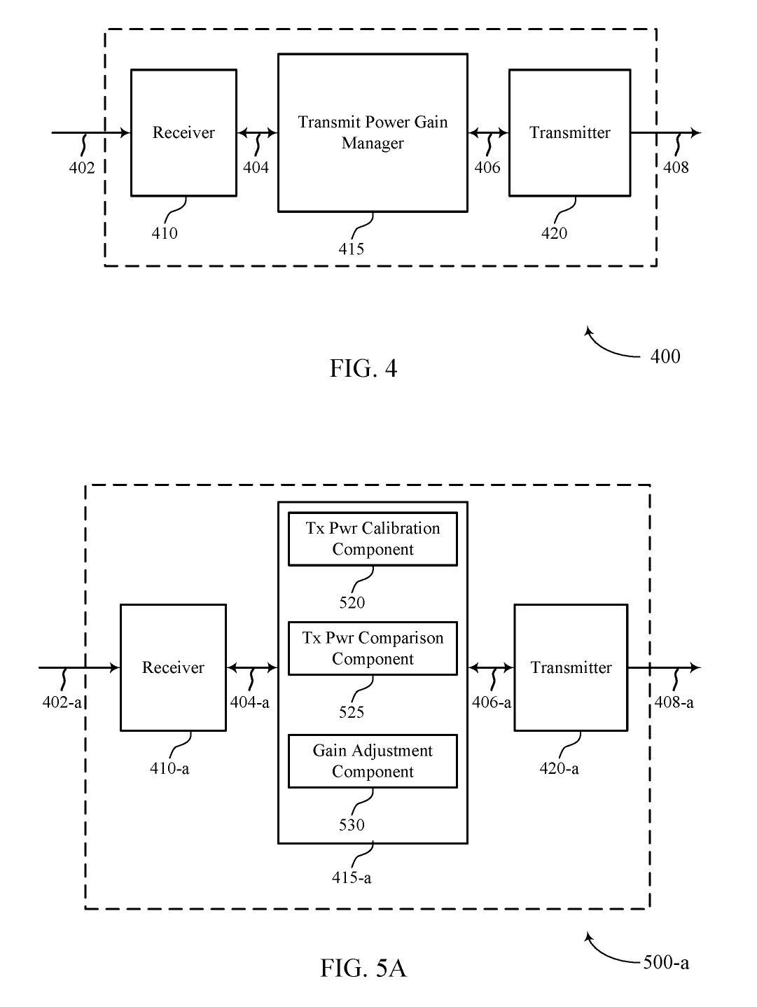

FIG. 4 shows a block diagram of a wireless device 400 that supports providing transmit power gain calibration and compensation in accordance with various aspects of the present disclosure. Wireless device 400 may be an example of aspects of an AP 105 or STA 115 as described with reference to FIG. 1, a wireless device 200 as described with reference to FIG. 2, or a wireless device 300 as described with reference to FIG. 3. Wireless device 400 may include receiver 410, transmit power gain manager 415, and transmitter 420. Wireless device 400 may also include a processor. Each of these components may be in communication with one another (e.g., via signal paths 402, 404, 406, 408 and/or one or more buses).

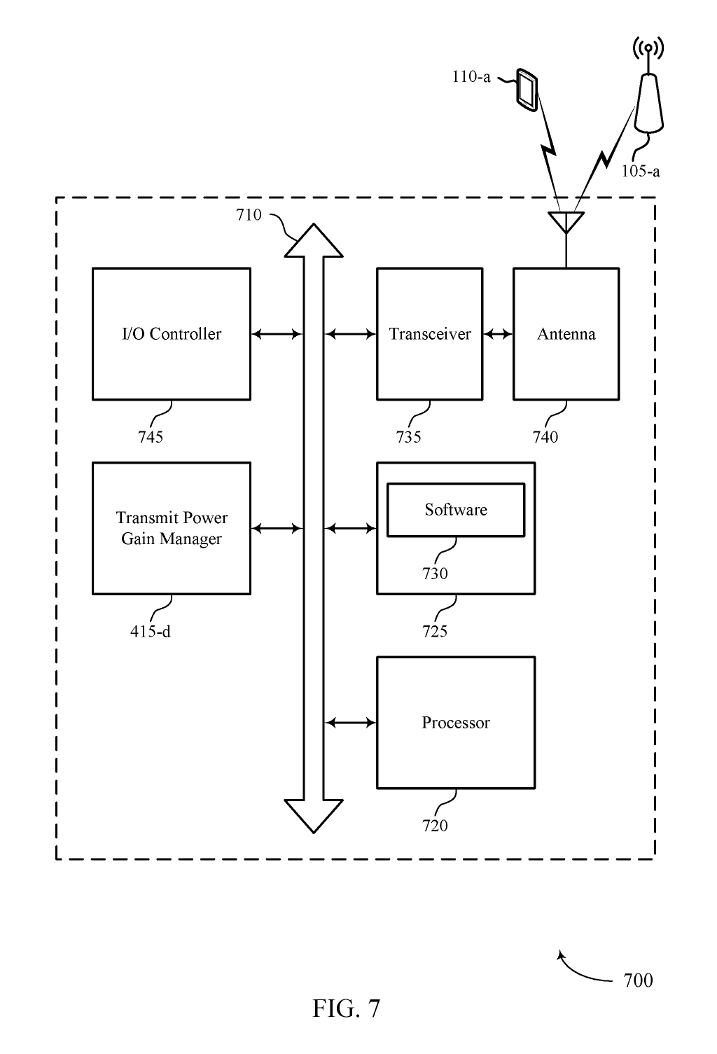

Receiver 410 may receive information such as packets, user data, or control information associated with various information channels (e.g., control channels, data channels, and information related to transmit power levels, etc.) via signal path 402. Receiver 410 may include a circuit or circuitry for receiving this information via signal path 402. Information received at receiver 410 may be passed on to transmit power gain manager 415 via signal path 404 and/or passed on to other components of wireless device 400. Receiver 410 may include a circuit or circuitry for providing information via signal path 404. The receiver 410 may be an example of aspects of the transceiver 735 described with reference to FIG. 7.

For example, receiver 410 may receive transmission performance information associated with the data transmitted to one or more receiving devices. This transmission performance information may be used to control transmit power from the transmitter 420. In some aspects, however, transmit power gain adjustments are made proactively by the wireless device 400 and irrespective of any transmission performance information. In this regard, the determination to adjust transmit power gain parameters is made without the use of transmission performance information provided by receiving wireless devices in accordance with some aspects.

Transmit power gain manager 415 may be used in conjunction with transmitter 420 to transmit a first calibration packet (e.g., a short packet that is different from a data packet) at a first power level. The first calibration packet may be transmitted based at least in part on a first transmit power gain index associated with the first power level. The first calibration packet may be a short packet relative to a typical data packet for the particular transmission standard associated with the packet to be transmitted. The first calibration packet may also include an indication that distinguishes the first calibration packet from a data packet. Transmit power gain manager 415 may determine a power measurement corresponding to the first calibration packet based at least in part feedback associated with a transmit power output of the first calibration packet (e.g., feedback from a measurement by a first transmit feedback circuit path, e.g., a transmit feedback circuit path extending from coupler 280-a, packet power detector 235-a, power-detect ADC 240-a, the accumulator 341, RF interface 331, PHY interface 329, transmit power LUT 327, and transmit power error determination and update component 315 to which feedback data 256-a is provided). The first transmit feedback circuit path (e.g., a feedback loop of the associated transmit chain) may include one or more components of the transmitter 420. Transmit power gain manager 415 may corresponding to the first calibration packet to a target power level associated with the first power level and may adjust one or more gain parameters associated with the first power level (e.g., the power level provided by a transmit power gain configuration that may include entries associated with one or more transmit power control LUTs) based at least in part on the comparing (i.e., comparing the determined corresponding to the first calibration packet to the target power level that was commanded).

Transmit power gain manager 415 may include a circuit or circuitry for comparing the power measurement corresponding to the first calibration packet to a target power level associated with the first power level, adjusting one or more gain parameters associated with the first power level, and/or receiving information via signal path 404.

In some examples, the transmit power gain manager 415 may be used in conjunction with transmitter 420 to select a transmit power gain configuration associated with a target transmit power of a data packet to be transmitted. The transmit power gain configuration (e.g., entries associated with one or more transmit power control LUTs) may include a first digital gain parameter associated with a first digital gain component (e.g., a DAC scaling network 320 of FIG. 3), a second digital gain parameter associated with a second digital gain component (e.g., a digital predistortion circuit 322 of FIG. 3). In this regard, the first digital gain component is different from the second digital gain component, and each of the first and second component may be controlled by different digital gain parameters. The transmit power gain configuration may also include an analog gain parameter associated with an analog gain component (e.g., a transmit baseband filter 330, 332, voltage-to-current converter 334, RF mixer 336, or power amplifier 338 of FIG. 3).

The transmit power gain manager 415 may determine to adjust the transmit power gain configuration based at least in part on changed transmission or operational conditions. For example, the transmit power gain manager 415 may determine to adjust the transmit power gain configuration based at least in part on a type of the data packet to be transmitted (e.g., based on the standard or specification for which the data packet is formatted), a type of transmission associated with the data packet to be transmitted (e.g., based at least in part on whether the data packet to be transmitted is associated with an MU-MIMO transmission), or a temperature measurement (e.g., based at least in part on whether a current measurement of the temperature is within a particular range of a temperature associated with transmit power gain configuration).

The transmit power gain manager 415 may adjust the first digital gain parameter without adjusting the second digital gain parameter and the analog gain parameter. For example, transmit power gain manager 415 may adjust the first digital gain parameter associated with the first digital gain component (e.g., a DAC scaling network 320 of FIG. 3) such that an increase in output power is expected to result as an output of the transmit chain. However, the transmit power gain manager 415 may keep the second digital gain parameter associated with the second digital gain component (e.g., a digital predistortion circuit 322 of FIG. 3) the same for that particular transmit power gain configuration. Similarly, the transmit power gain manager 415 may keep the analog gain parameter associated with the analog gain component (e.g., a transmit baseband filter 330, 332, voltage-to-current converter 334, RF mixer 336, or power amplifier 338 of FIG. 3) the same for that particular transmit power gain configuration. In this manner, power adjustments to one or more digital gain components can be used to proactively fine tune the transmit power level of a packet to be transmitted without changing the target transmit power level (e.g., a power level corresponding to the overall desired or commanded output power) and without performing data traffic-disruptive calibration procedures.

Transmit power gain manager 415 may include a circuit or circuitry for determining to adjust the transmit power gain configuration, adjusting the first digital gain parameter without adjusting the second digital gain parameter and the analog gain parameter, and/or receiving information via signal path 404. In some cases, transmit power gain manager 415 may be an example of aspects of the transmit power gain manager 715 described with reference to FIG. 7.

Transmitter 420 may transmit information and signals received from other components of wireless device 400, including information received via signal path 406 from transmit power gain manager 415. Transmitter 420 may transmit such information and signals via signal path 408 to other components of wireless device 400 and/or other wireless devices. In some examples, transmitter 420 may be collocated with receiver 410 in a transceiver module. For example, the transmitter 420 may be an example of aspects of the transceiver 735 described with reference to FIG. 7. Transmitter 420 may include a single antenna, or it may include a set of antennas. In some cases, the transmitter 420 may include one or more components comprising one or more transmit chains for wireless device 400. Transmitter 420 may include a circuit or circuitry for receiving information from the transmit power gain manager 415 via signal path 406 and for transmitting information and signals via signal path 408.

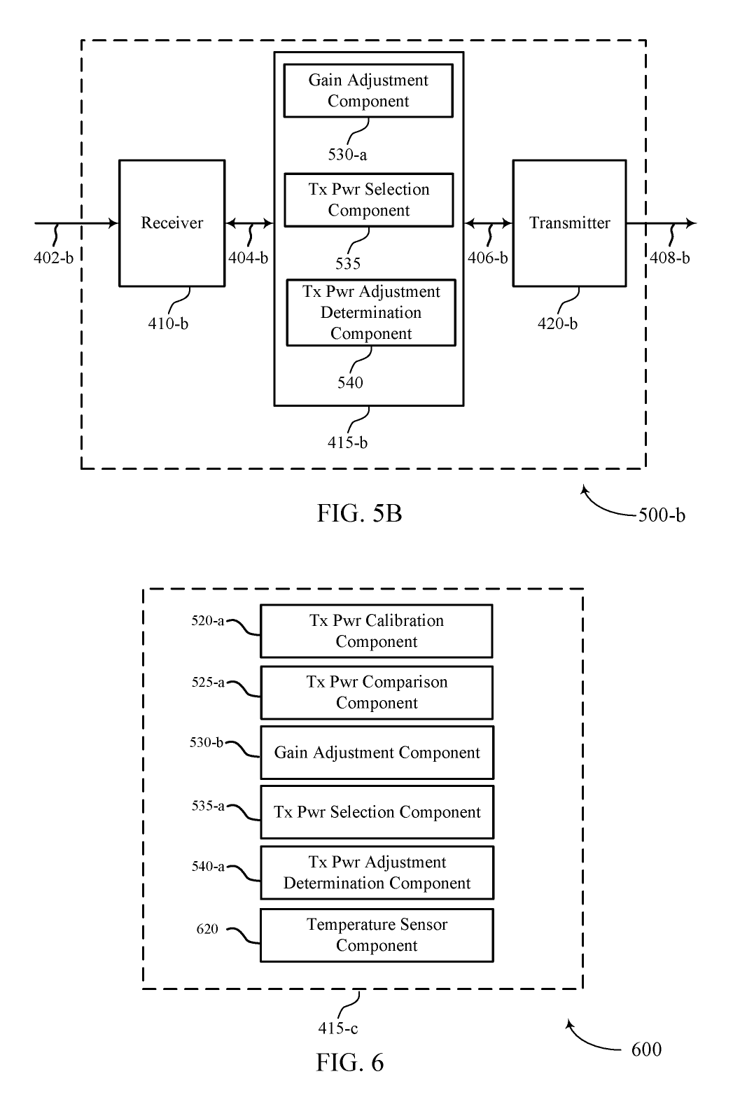

FIG. 5A shows a block diagram of a wireless device 500-a that supports providing transmit power gain calibration and compensation in accordance with various aspects of the present disclosure. Wireless device 500-a may be an example of aspects of an AP 105 or STA 115 as described with reference to FIG. 1, a wireless device 200 as described with reference to FIG. 2, a wireless device 300 as described with reference to FIG. 3, or a wireless device 400 or an AP 105 or STA 115 as described with reference to FIG. 4. Wireless device 500-a may include receiver 410-a, transmit power gain manager 415-a, and transmitter 420-a. Wireless device 500-a may also include a processor. Each of these components may be in communication with one another (e.g., via signal paths 402-a, 404-a, 406-a, 408-a and/or one or more buses).

Receiver 410-a may receive information such as packets, user data, or control information associated with various information channels (e.g., control channels, data channels, and information related to providing transmit power gain calibration and compensation, etc.). Information may be passed on to other components of the device. The receiver 410-a may be an example of aspects of the transceiver 735 described with reference to FIG. 7.

Transmit power gain manager 415-a may be an example of aspects of the transmit power gain manager 715 described with reference to FIG. 7. Transmit power gain manager 415-a may also include transmit power calibration component 520, transmit power comparison component 525, and gain adjustment component 530.

Transmit power calibration component 520 may transmit a first calibration packet at a first power level. The first calibration packet may be transmitted based at least in part on a first transmit power gain index associated with the first power level. The first calibration packet may include an indication that distinguishes the first calibration packet from a data packet. The indication that distinguishes the first calibration packet may include one or more bits set in a calibration field of the first calibration packet. Transmit power calibration component 520 may delay a transmission of a queued data packet until determining the power measurement corresponding to the first calibration packet. The queued data packet may be associated with a pending transmission to be transmitted at the first power level. In some examples, transmit power calibration component 520 may transmit a first data packet via the first transmit chain and transmit a second data packet via the second transmit chain, for example, after determining a power measurement corresponding to the first calibration packet and a power measurement corresponding to the second calibration packet associated with the respective transmit chains. Additionally, the first calibration packet may be shorter than a first scheduled data packet for transmission prior to the first calibration packet and may be shorter than a second scheduled data packet for transmission after the first calibration packet. In some cases, the transmitting a first calibration packet includes transmitting the first calibration packet based at least in part on an indication of a first temperature change. In some cases, the transmitting a first calibration packet at a first power level includes transmitting the first calibration packet at the first power level and a first frequency range. In some cases, the transmitting a second calibration packet at the first power level and a second frequency range. The second frequency range may be a different frequency range from the first frequency range. The second calibration packet may be transmitted based at least in part on a first transmit power gain index associated with the first power level.

Transmit power comparison component 525 may determine a power measurement corresponding to the first calibration packet based at least in part on feedback associated with a transmit power output of the first calibration packet (e.g., as measured by the first transmit feedback circuit path). Transmit power comparison component 525 may corresponding to the first calibration packet to a target power level associated with the first power level. In some examples, the transmit power comparison component 525 may determine a power measurement corresponding to the second calibration packet based at least in part on feedback associated with a transmit power output of the second calibration packet (e.g., as measured by a second transmit feedback circuit path, e.g., with similar components as the first feedback circuit path).

Gain adjustment component 530 may adjust one or more gain parameters (e.g., one or more digital and/or analog gain parameters) associated with the first power level (e.g., a power level as provided by a transmit power gain configuration and associated transmit power gain index, e.g., transmit power gain index 205-a of FIG. 3) based at least in part on the comparing. The one or more gain parameters may associated with a transmit power gain index (e.g., transmit power gain index 205-a of FIG. 3) and a temperature at which the transmit power gain index (e.g., transmit power gain index 205-a of FIG. 3) was calibrated. For example, the one or more gain parameters may be adjusted by the gain adjustment component 530 based at least in part on determining that a current temperature of the wireless device 500-a differs for the temperature at which the transmit power gain index (e.g., transmit power gain index 205-a of FIG. 3) used for the power level for transmitting a calibration packet or a data packet was calibrated. Gain adjustment component 530 may apply one or more gain parameters associated with the first transmit power gain configuration to a first transmit chain. Gain adjustment component 530 may adjust the one or more gain parameters (e.g., one or more digital and/or analog gain parameters) associated with the first power level based at least in part on the comparing the power measurement corresponding to the second calibration packet to the target power level. Additionally, the gain adjustment component 530 may apply one or more gain parameters associated with the first power level to a second transmit chain. In some cases, the adjusting one or more gain parameters associated with first power level includes modifying or adjusting one or more digital gain parameters provided by a first transmit power gain configuration associated with a first transmit power gain index (e.g., transmit power gain index 205-a of FIG. 3). For example, the first transmit power gain index (e.g., transmit power gain index 205-a of FIG. 3) may be used to transmit the first calibration packet at the first power level. In some cases, the adjusting one or more gain parameters associated with the first power level includes selecting a set of digital and analog gain parameters provided by a second transmit power gain configuration associated with a second transmit power gain index (e.g., transmit power gain index 205-a of FIG. 3). The second transmit power gain index (e.g., transmit power gain index 205-a of FIG. 3) may be different from a first transmit power gain index 205-a of FIG. 3, where the first transmit power gain index (e.g., transmit power gain index 205-a of FIG. 3) may be transmit power gain index (e.g., transmit power gain index 205-a of FIG. 3) used to transmit the first calibration packet at the first power level. Gain adjustment component 530 may change one or more analog gain parameters based on a change in the transmit power gain index (e.g., transmit power gain index 205-a of FIG. 3) and/or may adjust one or more analog gain parameters associated with various transmit power gain configurations based on a calibration procedure. In this regard, the adjusting one or more gain parameters associated with the first power level may include adjusting one or more analog gain parameters in accordance with some examples.

Transmitter 420-a may transmit signals generated by other components of the device. In some examples, the transmitter 420-a may be collocated with a receiver 410-a in a transceiver module. For example, the transmitter 420-a may be an example of aspects of the transceiver 735 described with reference to FIG. 7. The transmitter 420-a may include a single antenna, or it may include a set of antennas.

FIG. 5B shows a block diagram of a wireless device 500-b that supports providing transmit power gain calibration and compensation in accordance with various aspects of the present disclosure. Wireless device 500-b may be an example of aspects of an AP 105 or STA 115 as described with reference to FIG. 1, a wireless device 200 as described with reference to FIG. 2, a wireless device 300 as described with reference to FIG. 3, a wireless device 400 as described with reference to FIG. 4, or a wireless device 500-a as described with reference to FIG. 5A. Wireless device 500-b may include receiver 410-b, transmit power gain manager 415-b, and transmitter 420-b. Wireless device 500-b may also include a processor. Each of these components may be in communication with one another (e.g., via signal paths 402-b, 404-b, 406-b, 408-b and/or one or more buses).

Receiver 410-b may receive information such as packets, user data, or control information associated with various information channels (e.g., control channels, data channels, and information related to providing transmit power gain calibration and compensation, etc.). Information may be passed on to other components of the device. The receiver 410-b may be an example of aspects of the transceiver 735 described with reference to FIG. 7.

Transmit power gain manager 415-b may be an example of aspects of the transmit power gain manager 715 described with reference to FIG. 7. Transmit power gain manager 415-b may also include gain adjustment component 530-a, transmit power selection component 535, and transmit power adjustment determination component 540.

Transmit power selection component 535 may select a transmit power gain configuration associated with a target transmit power of a data packet to be transmitted, the transmit power gain configuration including a first digital gain parameter associated with a first digital gain component, a second digital gain parameter associated a second digital gain component that is different from the first digital gain component, and an analog gain parameter associated with an analog gain component.

Transmit power adjustment determination component 540 may determine to adjust the transmit power gain configuration based at least in part on changed transmission or operational conditions (e.g., a type of the data packet to be transmitted, a type of transmission associated with the data packet to be transmitted, or a temperature measurement).

Gain adjustment component 530-a may adjust the first digital gain parameter without adjusting the second digital gain parameter and the analog gain parameter.

Transmitter 420-b may transmit signals generated by other components of the device. In some examples, the transmitter 420-b may be collocated with a receiver 410-b in a transceiver module. For example, the transmitter 420-b may be an example of aspects of the transceiver 735 described with reference to FIG. 7. The transmitter 420-b may include a single antenna, or it may include a set of antennas.

FIG. 6 shows a block diagram 600 of a transmit power gain manager 415-c that supports providing transmit power gain calibration and compensation in accordance with various aspects of the present disclosure. The transmit power gain manager 415-c may be an example of aspects of a transmit power gain manager 415-a, a transmit power gain manager 415-b, or a transmit power gain manager 415-d described with reference to FIGS. 4, 5, and 7. The transmit power gain manager 415-c may include may include transmit power calibration component 520-a, transmit power comparison component 525-a, gain adjustment component 530-b, transmit power selection component 535-a, transmit power adjustment determination component 540-a, and temperature sensor component 620. Each of these components may communicate, directly or indirectly, with one another (e.g., via one or more buses).

Transmit power calibration component 520-a may transmit a first calibration packet at a first power level. The first calibration packet may be transmitted based at least in part on a first transmit power gain index associated with the first power level. The first calibration packet may also include an indication that distinguishes the first calibration packet from a data packet. Transmit power calibration component 520-a may delay a transmission of a queued data packet until determining the power measurement corresponding to the first calibration packet, the queued data packet being associated with a pending transmission to be transmitted at the first power level. Transmit power calibration component 520-a may transmit a first data packet via the first transmit chain, and transmit a second data packet via the second transmit chain.

In some cases, the indication that distinguishes the first calibration packet may include one or more bits set in a calibration field. The first calibration packet may be shorter than a first scheduled data packet for transmission prior to the first calibration packet and is shorter than a second scheduled data packet for transmission after the first calibration packet. In some examples, the first calibration packet, the first scheduled data packet, and the second scheduled data packet may all be transmitted in a same transmission frame as designated by the relevant standard for which packets are transmitted by a wireless device employing the transmit power gain manager 415-c. In some cases, a first calibration packet may be transmitted based at least in part on an indication of a first temperature change. In some cases, the first calibration packet may be transmitted at the first power level and a first frequency range. In some cases, a second calibration packet may be transmitted at the first power level and a second frequency range. The second frequency range may be different from the first frequency range.

Transmit power comparison component 525-a may determine a power measurement corresponding to the first calibration packet based at least in part on feedback associated with a transmit power output of the first calibration packet (e.g., as measured by a first transmit feedback circuit path). Transmit power comparison component 525-a may compare the power measurement corresponding to the first calibration packet to a target power level associated with the first power level. Transmit power comparison component 525-a determine a power measurement corresponding to the second calibration packet based at least in part on feedback associated with a transmit power output of the second calibration packet (e.g., as measured by a second transmit feedback circuit path). Additionally, transmit power comparison component 525-a may detect a calibration packet among a plurality of data packets, measure a transmit power level associated with the calibration packet, and compare the transmit power with the target transmit power.

Gain adjustment component 530-b may adjust one or more gain parameters (e.g., one or more digital and/or analog gain parameters) associated with a first power level based at least in part on the comparing. Gain adjustment component 530-b may apply one or more gain parameters associated with the first power level to a first transmit chain. Gain adjustment component 530-b may adjust the one or more gain parameters (e.g., one or more digital and/or analog gain parameters) associated with the first power level based at least in part on the comparing the power measurement associated with a second calibration packet to the target power level. Gain adjustment component 530-b may apply the one or more gain parameters associated with the first power level to a second transmit chain. Additionally, gain adjustment component 530-b may identify an adjustment value for the first digital gain parameter based at least in part on a temperature (e.g., a current temperature reading associated with wireless device employing the transmit power gain manager 415-c or a component thereof).

In some cases, the adjusting one or more gain parameters associated with a first power level includes modifying or adjusting adjust one or more digital gain parameters provided by a first transmit power gain configuration associated with a first transmit power gain index (e.g., transmit power gain index 205-a of FIG. 3), the first transmit power gain index (e.g., transmit power gain index 205-a of FIG. 3) being used to transmit the first calibration packet at the first power level. In some cases, the adjusting one or more gain parameters associated with a first power level includes selecting a set of digital and analog gain parameters provided by a second transmit power gain configuration associated with a second transmit power gain index (e.g., transmit power gain index 205-a of FIG. 3), the second transmit power gain index (e.g., transmit power gain index 205-a of FIG. 3) different from a first transmit power gain index (e.g., transmit power gain index 205-a of FIG. 3), the first transmit power gain index (e.g., transmit power gain index 205-a of FIG. 3) being used to transmit the first calibration packet at the first power level.

Transmit power selection component 535-a may select a transmit power gain configuration associated with a target transmit power of a data packet to be transmitted, the transmit power gain configuration including a first digital gain parameter associated with a first digital gain component, a second digital gain parameter associated a second digital gain component that is different from the first digital gain component, and an analog gain parameter associated with an analog gain component.

Transmit power adjustment determination component 540-a may initiate and/or perform a transmit power gain calibration procedure based at least in part on an indication of a second temperature change, the second temperature change being different from the first temperature change.

Temperature sensor component 620 may determine a temperature associated with the transmit chain of the data packet to be transmitted.

FIG. 7 shows a diagram of a system including a device 700 that supports providing transmit power gain calibration and compensation in accordance with various aspects of the present disclosure. Device 700 may be an example of or include the components of may be an example of aspects of an AP 105 as described with reference to FIG. 1, a wireless device 200 as described with reference to FIG. 2, a wireless device 300 as described with reference to FIG. 3, a wireless device 400 as described with reference to FIG. 4, or a wireless device 500-a as described with reference to FIG. 5A, or a wireless device 500-b as described with reference to FIG. 5B. Device 700 may include components for bi-directional voice and data communications including components for transmitting and receiving communications, including transmit power gain manager 415-d, processor 720, memory 725, software 730, transceiver 735, antenna 740, and I/O controller 745.

Processor 720 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks to support providing transmit power gain calibration and compensation).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a Basic Input-Output system (BIOS) which may control basic hardware and/or software operation such as the interaction with peripheral components or devices.

Software 730 may include code to implement aspects of the present disclosure, including code to support providing transmit power gain calibration and compensation. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. Input/output control component 745 may also manage peripherals not integrated into device 705. In some cases, input/output control component 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system.

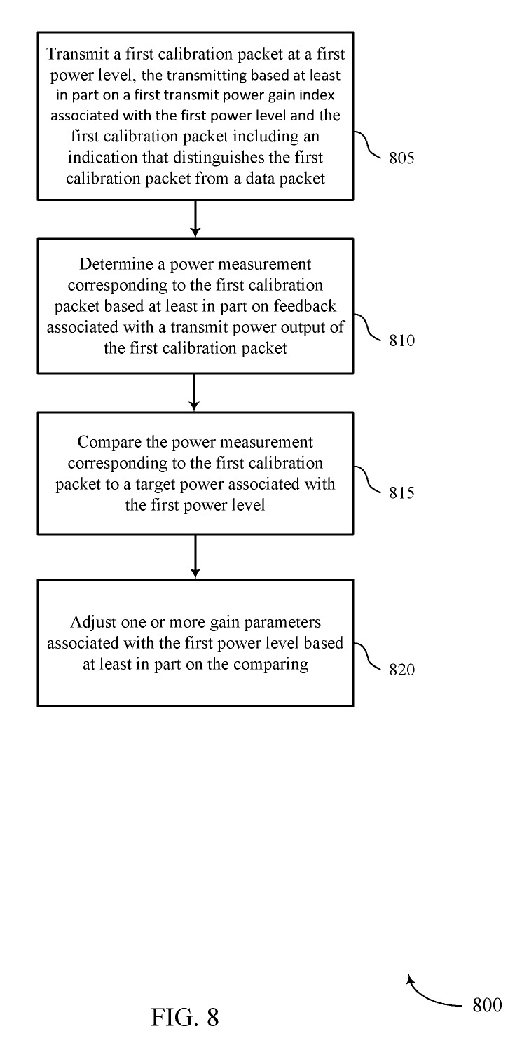

FIG. 8 shows a flowchart illustrating a method 800 for providing transmit power gain calibration and compensation in accordance with various aspects of the present disclosure. The operations of method 800 may be implemented by an AP 105 or its components as described herein. In other examples, the operations of method 800 may be implemented by a STA 115 or its components as described herein. For example, the operations of method 800 may be performed by a transmit power gain manager as described with reference to FIGS. 4 through 7. In some examples, an AP 105 may execute a set of codes to control the functional elements of the device to perform the functions described below. Additionally or alternatively, the AP 105 may perform aspects the functions described below using special-purpose hardware.

At block 805 the AP 105 may transmit a first calibration packet at a first power level. The first calibration packet may be transmitted based at least in part on a first transmit power gain index associated with the first power level. The first calibration packet may comprise an indication that distinguishes the first calibration packet from a data packet. The operations of block 805 may be performed according to the techniques described with reference to FIGS. 1 through 3. In certain examples, aspects of the operations of block 805 may be performed by a transmit power calibration component in cooperation or incorporated with a transmitter as described with reference to FIGS. 4 through 7.

At block 810 the AP 105 may determine a power measurement corresponding to the first calibration packet based at least in part on feedback associated with a transmit power output of the first calibration packet (e.g., as measured by a first transmit feedback circuit path). The operations of block 810 may be performed according to the techniques described with reference to FIGS. 1 through 3. In certain examples, aspects of the operations of block 810 may be performed by a transmit power comparison component as described with reference to FIGS. 4 through 7.

At block 815 the AP 105 may compare the power measurement corresponding to the first calibration packet to a target power level associated with the first power level. The operations of block 815 may be performed according to the techniques described with reference to FIGS. 1 through 3. In certain examples, aspects of the operations of block 815 may be performed by a transmit power comparison component as described with reference to FIGS. 4 through 7.

At block 820 the AP 105 may adjust one or more gain parameters associated with the first power level based at least in part on the comparing. The operations of block 820 may be performed according to the techniques described with reference to FIGS. 1 through 3. In certain examples, aspects of the operations of block 820 may be performed by a gain adjustment component as described with reference to FIGS. 4 through 7.

It is to be appreciated that, in some cases, one or a few calibration packets can be used to improve the dynamic range of the transmitter as well as of the receiver of the receiving device associated with the transmitter using techniques for providing transmit power gain calibration and compensation described herein and, for example, with respect to FIG. 8. In some examples, a first calibration packet can be used to determine a highest transmit power gain index (e.g., transmit power gain index 205-a of FIG. 3) and the proper adjustments to the one or more gain parameters associated with the highest transmit power gain (e.g., transmit power gain index 205-a of FIG. 3). The remaining set of transmit power gain indexes (e.g., transmit power gain indexes 205-a of FIG. 3) required to cover an entire dynamic range of the desired transmission (e.g., the dynamic range corresponding to a receiver of the receiving device) can be determined by: (i) repeating for calibration process with calibration packets for all transmit all transmit power gain indexes (e.g., transmit power gain indexes 205-a of FIG. 3) associated with the dynamic range of the desired transmission; (ii) applying a common offset (e.g., difference between expected transmit power output and measured transmit power output) based at least in part on the measured transmit power output associated with the first calibration packet and the number of transmit power gain indexes (e.g., transmit power gain indexes 205-a of FIG. 3) within the dynamic range of the desired transmission (e.g., P(i+1)=P(i)−Delta, where i=1 to n, 0<Delta<=Tx_Dynamic_Range/Number_of_Tx_Pwr_Gain_Indexes); or (iii) applying a sequential offset based at least in part on transmitter device characteristics or operational parameters for adjusting the other transmit power gain indexes (e.g., transmit power gain indexes 205-a of FIG. 3) within the dynamic range of the desired transmission based at least in part on the measured transmit power output associated with the first calibration packet.

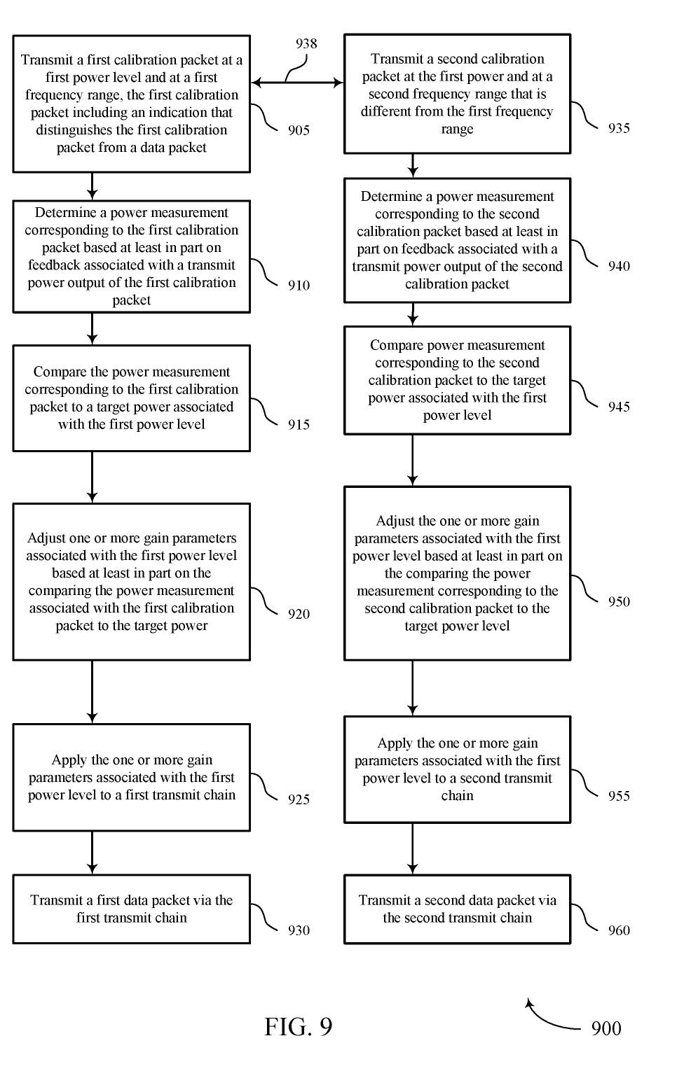

FIG. 9 shows a flowchart illustrating a method 900 for providing transmit power gain calibration and compensation in accordance with various aspects of the present disclosure. The operations of method 900 may be implemented by an AP 105 or its components as described herein. In other examples, the operations of method 900 may be implemented by a STA 115 or its components as described herein. In other examples, the operations of method 900 may be implemented by a STA 115 or its components as described herein. For example, the operations of method 900 may be performed by a transmit power gain manager as described with reference to FIGS. 4 through 7. In some examples, an AP 105 may execute a set of codes to control the functional elements of the device to perform the functions described below. Additionally or alternatively, the AP 105 may perform aspects the functions described below using special-purpose hardware.

At block 905 the AP 105 may transmit a first calibration packet at a first power level and a first frequency range. The first calibration packet may be transmitted based at least in part on a first transmit power gain index associated with the first power level. The first calibration packet may comprise an indication that distinguishes the first calibration packet from a data packet. In some options, the indication that distinguishes the first calibration packet comprises one or more bits set in a calibration field (e.g., in a header portion of the first calibration packet). In some options, the first calibration packet may be shorter than a first scheduled data packet for transmission prior to the first calibration packet and may be shorter than a second scheduled data packet for transmission after the first calibration packet. In some options, the transmitting the first calibration packet by the AP 105 may be based at least in part on an indication of a first temperature change. The first temperature change may be associated with a value change that would generally require a fine-tune adjustment of the transmit power. In yet other options, the AP 105 may additionally, perform a transmit power gain calibration procedure based at least in part on an indication of a second temperature change. The second temperature change may be different from the first temperature change and be associated with a larger value change than the first temperature change. The second temperature change being such that AP 105 may require a reselection of the transmit power gain index (e.g., transmit power gain index 205-a of FIG. 3) used for the first power level or a recalibration of the transmit power gain operations.

The operations of block 905 may be performed according to the techniques described with reference to FIGS. 1 through 3. In certain examples, aspects of the operations of block 905 may be performed by a transmit power calibration component in cooperation or incorporated with a transmitter as described with reference to FIGS. 4 through 7.

At block 910 the AP 105 may determine a power measurement corresponding to the first calibration packet based at least in part on feedback associated with a transmit power output of the first calibration packet (e.g., as measured by a first transmit feedback circuit path). The operations of block 910 may be performed according to the techniques with reference to FIGS. 1 through 3. In certain examples, aspects of the operations of block 910 may be performed by a transmit power comparison component as described with reference to FIGS. 4 through 7.

At block 915 the AP 105 may compare the power measurement corresponding to the first calibration packet to a target power level associated with the first power level. The operations of block 915 may be performed according to the techniques described with reference to FIGS. 1 through 3. In certain examples, aspects of the operations of block 915 may be performed by a transmit power comparison component as described with reference to FIGS. 4 through 7.

At block 920 the AP 105 may adjust one or more gain parameters associated with associated with the first power level based at least on the comparing the power measurement corresponding to the first calibration packet to the target power level associated with the first power level. In some options, the adjusting of the one or more gain parameters by the AP 105 can be by adjusting or modifying one or more digital gain parameters (e.g., as provided by a first transmit power gain configuration) associated with a first transmit power gain index. The first transmit power gain index may be the transmit power gain index used to transmit the first calibration packet at the first power level. In other options, the adjusting of one or more gain parameters by the AP 105 can be by selecting set of digital and analog gain parameters (e.g., as provided by a second transmit power gain configuration) associated with a second transmit power gain index. The second transmit power gain index may be a different transmit power gain index from a first transmit power gain index. In some cases, the first transmit power gain index may be the transmit power gain index used to transmit the first calibration packet at the first power level. In some examples, the one or more gain parameters may be associated with a transmit power gain index and a temperature at which the transmit power gain index was calibrated.

The operations of block 920 may be performed according to the techniques described with reference to FIGS. 1 through 3. In certain examples, aspects of the operations of block 920 may be performed by a gain adjustment component as described with reference to FIGS. 4 through 7.

At block 925 the AP 105 may apply one or more gain parameters associated with the first power level to a first transmit chain. For example, the one or more gain parameters associated with the first power level may correspond to the power level associated with a transmit power gain index and gain parameters (e.g., as provided by a first or second transmit power gain configuration). The operations of block 925 may be performed according to the techniques described with reference to FIGS. 1 through 3. In certain examples, aspects of the operations of block 925 may be performed by a gain adjustment component as described with reference to FIGS. 4 through 7.

At block 930 the AP 105 may transmit a first data packet via the first transmit chain. In some options, the AP 105 may delay a transmission of a queued data packet until determining the power measurement associated with the first calibration packet, the queued data packet being associated with a pending transmission to be transmitted at the first power level.

The operations of block 930 may be performed according to the techniques described with reference to FIGS. 1 through 3. In certain examples, aspects of the operations of block 930 may be performed by a transmit power calibration component in cooperation or incorporated with a transmitter as described with reference to FIGS. 4 through 7.

At block 935 the AP 105 may transmit a second calibration packet at the first power level and at a second frequency range that is different from the first frequency range. The operations of block 935 may be performed according to the techniques described with reference to FIGS. 1 through 3. In certain examples, aspects of the operations of block 935 may be performed by a transmit power calibration component in cooperation or incorporated with a transmitter as described with reference to FIGS. 4 through 7.

In some examples, the operations of block 905 and block 935 may be concurrent operations 938. For example, operations of block 905 and block 935 may be performed during a same time slot (e.g., subframe or transmission time interval (TTI) for transmitting data) of a transmission frame as designated by the relevant standard for which packets are transmitted by the first and second transmit chains (e.g., an MU-MIMO transmission in accordance with IEEE 802.11ac). The short calibration packet may be a 20 μs packet and impact to data traffic may therefore be negligible. Moreover, transmission of the short calibration packet may be limited to instances when changed transmission or operational conditions are detected. Such detected instances may include, but are not limited to, a type of the data packet to be transmitted (e.g., some packet types may not require calibration processes using the short calibration packet), a type of transmission associated with the data packet to be transmitted (e.g., transmit short calibration packets only when the data transmission is associated with switching channels for SU-MIMO or MU-MIMO transmissions), or a temperature measurement (e.g., transmit short calibration packets only when a significant temperature change has been detected). Additionally or alternatively, in some examples, the first calibration packet and a data packet associated with the first calibration packet and the first power level thereof may be transmitted during a same time slot of a transmission frame as designated by the relevant standard for which packets are transmitted by the first transmit chain.

Similarly, in some examples, the second calibration packet and a data packet associated with the second calibration packet and the first power level thereof may be transmitted during a same time slot of a same transmission frame as designated by the relevant standard for which packets are transmitted by the second transmit chain. In other examples, the first and second calibration packets may be transmitted during an earlier time slot and the associated data packets may be transmitted during a subsequent time slot of a same transmission frame as designated by the relevant standard for which packets are transmitted by the first and second transmit chains. In this manner, transmit power gain LUT determinations for noncontiguous 80+80-MHz mode of WLAN operation may be performed for each individual frequency segment on the respective transmit chains. As such, first power measurement estimates or determinations can be acquired for both transmit chains in one time slot.

At block 940 the AP 105 may determine a power measurement corresponding to the second calibration packet based at least in part on feedback associated with a transmit power output of the second calibration packet (e.g., as measured by a second transmit feedback circuit path). In some cases, the second transmit feedback circuit path is a different feedback circuit path than the first transmit feedback circuit path (e.g., components of a different transceiver circuit of AP 105 than the first transmit feedback circuit path). In other cases, the second transmit feedback circuit path can be the same feedback circuit path than the first transmit feedback circuit path or include one or more shared components with the first transmit feedback circuit path. The operations of block 940 may be performed according to the techniques described with reference to FIGS. 1 through 3. In certain examples, aspects of the operations of block 940 may be performed by a transmit power comparison component as described with reference to FIGS. 4 through 7.

At block 945 the AP 105 may compare the power measurement corresponding to the second calibration packet to the target power level associated with the first power level. The operations of block 945 may be performed according to the techniques described with reference to FIGS. 1 through 3. In certain examples, aspects of the operations of block 945 may be performed by a gain comparison component as described with reference to FIGS. 4 through 7.

At block 950 the AP 105 may adjust the one or more gain parameters associated with the first power level based at least in part on the comparing the power measurement associated with the second calibration packet to the target power level. The operations of block 950 may be performed according to the techniques described with reference to FIGS. 1 through 3. In certain examples, aspects of the operations of block 950 may be performed by a gain adjustment component as described with reference to FIGS. 4 through 7.

At block 955 the AP 105 may apply the one or more gain parameters associated with the first power level to a second transmit chain. In some cases, the second transmit chain is a different transmit chain than the first transmit chain (e.g., components of a different transceiver circuit of AP 105 than the first transmit chain). In other cases, the second transmit chain can be the same transmit chain than the first transmit chain or include one or more shared components with the first transmit chain. The operations of block 955 may be performed according to the techniques described with reference to FIGS. 1 through 3. In certain examples, aspects of the operations of block 955 may be performed by a gain adjustment component as described with reference to FIGS. 4 through 7.

At block 960 the AP 105 may transmit a second data packet via the second transmit chain. The operations of block 960 may be performed according to the techniques described with reference to FIGS. 1 through 3. In certain examples, aspects of the operations of block 960 may be performed by a transmit power calibration component as described with reference to FIGS. 4 through 7.

It is to be appreciated that based on the frequency range differences per per-board (e.g., per-WLAN transceiver circuit board) variations, the resulting or actual transmit power output may differ significantly (e.g., based on a same transmit power gain index). For certain transceiver circuit types (e.g., Type-A circuits), a same set of transmit power gain indexes may be required for use across multiple bandwidth segments. In a noncontiguous 80+80-MHz mode of WLAN operation with such transceiver circuit types, the transmit power gain indexes may be set across the two bandwidth segments by (i) selecting a common transmit power gain index associated with a frequency approximately midway between the two bandwidth segments or (ii) selecting a transmit power gain index that is optimized for one bandwidth segment at the expense of performance of the other bandwidth segment. Techniques for providing transmit power gain calibration and compensation described herein and, for example, with respect to FIG. 9 may be used to first determine the optimized transmit power gain index for use with each bandwidth segment and corresponding transmit chain(s). Other transceiver circuit types (e.g., Type-B circuits), transmit power gain indexes can be set independently across multiple bandwidth segments, and may thereby take full advantage of the techniques for providing transmit power gain calibration and compensation described herein.

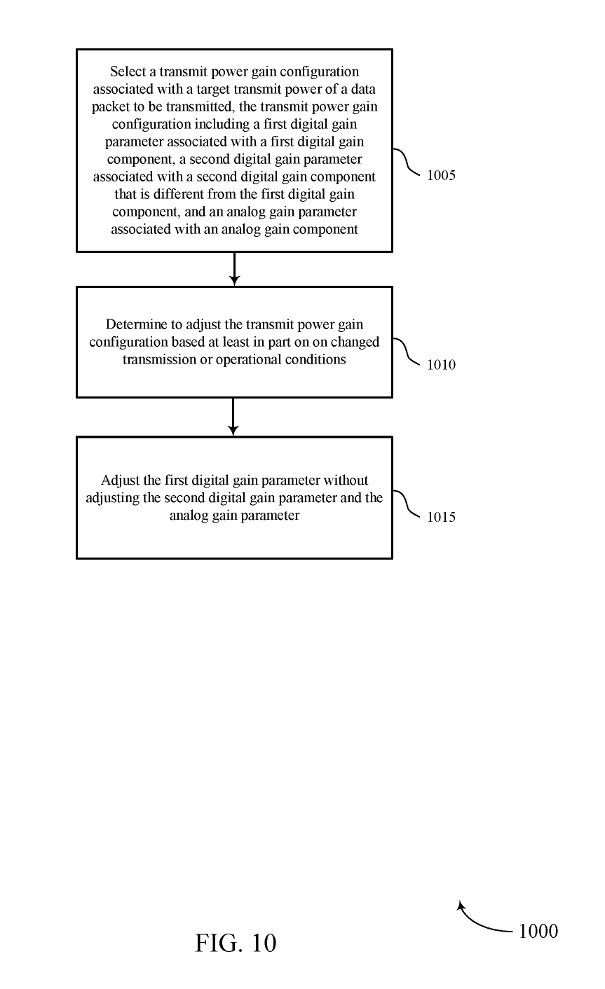

FIG. 10 shows a flowchart illustrating a method 1000 for providing transmit power gain calibration and compensation in accordance with various aspects of the present disclosure. The operations of method 1000 may be implemented by an AP 105 or its components as described herein. In other examples, the operations of method 1000 may be implemented by a STA 115 or its components as described herein For example, the operations of method 1000 may be performed by a transmit power gain manager as described with reference to FIGS. 4 through 7. In other examples, the operations of method 1000 may be implemented by a STA 115 or its components as described herein. In some examples, an AP 105 may execute a set of codes to control the functional elements of the device to perform the functions described below. Additionally or alternatively, the AP 105 may perform aspects the functions described below using special-purpose hardware.

At block 1005 the AP 105 may select a transmit power gain configuration associated with a target power level of a data packet to be transmitted, the transmit power gain configuration including a first digital gain parameter associated with a first digital gain component, a second digital gain parameter associated a second digital gain component that is different from the first digital gain component, and an analog gain parameter associated with an analog gain component. In some cases, the second digital gain parameter associated with the second digital gain component can be a digital parameter that is determined based at least in part on a transmit power gain index (e.g., digital predistortion circuit 322 providing the digital parameter based at least in part on receiving the transmit power gain index 205-a from the transmit power digital gain LUT of FIG. 3). The operations of block 1005 may be performed according to the techniques described with reference to FIGS. 1 through 3. In certain examples, aspects of the operations of block 1005 may be performed by a transmit power selection component as described with reference to FIGS. 4 through 7.

At block 1010 the AP 105 may determine to adjust the transmit power gain configuration based at least in part on changed transmission or operational conditions (e.g., a type of the data packet to be transmitted, a type of transmission associated with the data packet to be transmitted, or a temperature measurement). The operations of block 1010 may be performed according to the techniques described with reference to FIGS. 1 through 3. In certain examples, aspects of the operations of block 1010 may be performed by a transmit power adjustment determination component as described with reference to FIGS. 4 through 7.

At block 1015 the AP 105 may adjust the first digital gain parameter without adjusting the second digital gain parameter and the analog gain parameter. The operations of block 1015 may be performed according to the techniques described with reference to FIGS. 1 through 3. In certain examples, aspects of the operations of block 1015 may be performed by a gain adjustment component as described with reference to FIGS. 4 through 7.

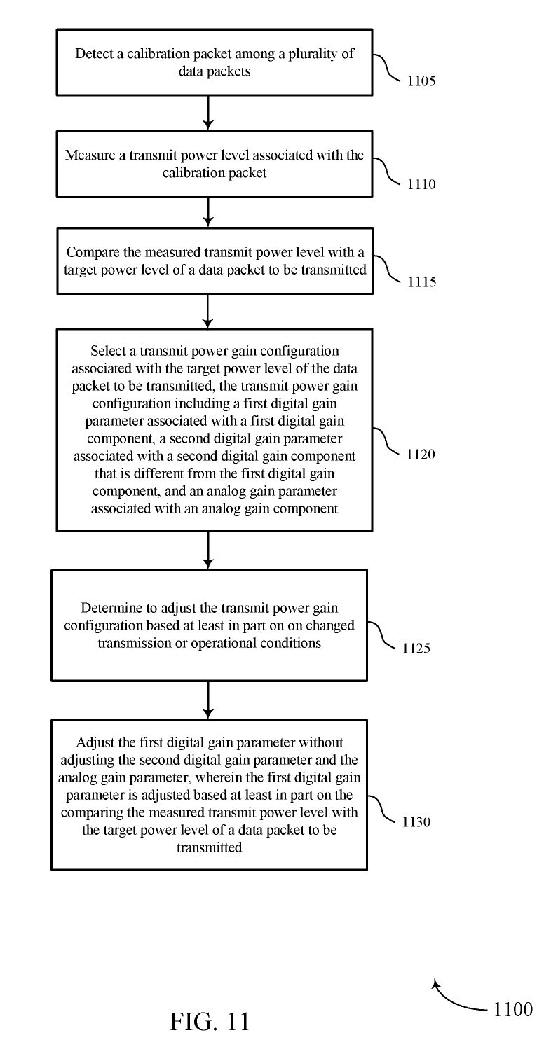

FIG. 11 shows a flowchart illustrating a method 1100 for providing transmit power gain calibration and compensation in accordance with various aspects of the present disclosure. The operations of method 1100 may be implemented by an AP 105 or its components as described herein. In other examples, the operations of method 1100 may be implemented by a STA 115 or its components as described herein For example, the operations of method 1100 may be performed by a transmit power gain manager as described with reference to FIGS. 4 through 7. In some examples, an AP 105 may execute a set of codes to control the functional elements of the device to perform the functions described below. Additionally or alternatively, the AP 105 may perform aspects the functions described below using special-purpose hardware.

At block 1105 the AP 105 may detect a calibration packet among a plurality of data packets. The operations of block 1105 may be performed according to the techniques described with reference to FIGS. 1 through 3. In certain examples, aspects of the operations of block 1105 may be performed by a transmit power comparison component as described with reference to FIGS. 4 through 7.

At block 1110 the AP 105 may measure a transmit power level associated with the calibration packet. The operations of block 1110 may be performed according to the techniques described with reference to FIGS. 1 through 3. In certain examples, aspects of the operations of block 1110 may be performed by a transmit power comparison component as described with reference to FIGS. 4 through 7.

At block 1115 the AP 105 may compare the measured transmit power level with the target transmit power level. The operations of block 1115 may be performed according to the techniques described with reference to FIGS. 1 through 3. In certain examples, aspects of the operations of block 1115 may be performed by a transmit power comparison component as described with reference to FIGS. 4 through 7.

At block 1120 the AP 105 may select a transmit power gain configuration associated with a target power level of a data packet to be transmitted, the transmit power gain configuration including a first digital gain parameter associated with a first digital gain component, a second digital gain parameter associated a second digital gain component that is different from the first digital gain component, and an analog gain parameter associated with an analog gain component. The operations of block 1120 may be performed according to the techniques described with reference to FIGS. 1 through 3. In certain examples, aspects of the operations of block 1120 may be performed by a transmit power selection component as described with reference to FIGS. 4 through 7.

At block 1125 the AP 105 may determine to adjust the transmit power gain configuration based at least in part on changed transmission or operational conditions (e.g., a type of the data packet to be transmitted, a type of transmission associated with the data packet to be transmitted, or a temperature measurement). The operations of block 1125 may be performed according to the techniques described with reference to FIGS. 1 through 3. In certain examples, aspects of the operations of block 1125 may be performed by a transmit power adjustment determination component as described with reference to FIGS. 4 through 7.

At block 1130 the AP 105 may adjust the first digital gain parameter without adjusting the second digital gain parameter and the analog gain parameter. The first digital gain parameter may be adjusted based at least in part on the comparing the measured transmit power level with the target power level of a data packet to be transmitted. The operations of block 1130 may be performed according to the techniques described with reference to FIGS. 1 through 3. In certain examples, aspects of the operations of block 1130 may be performed by a gain adjustment component as described with reference to FIGS. 4 through 7.

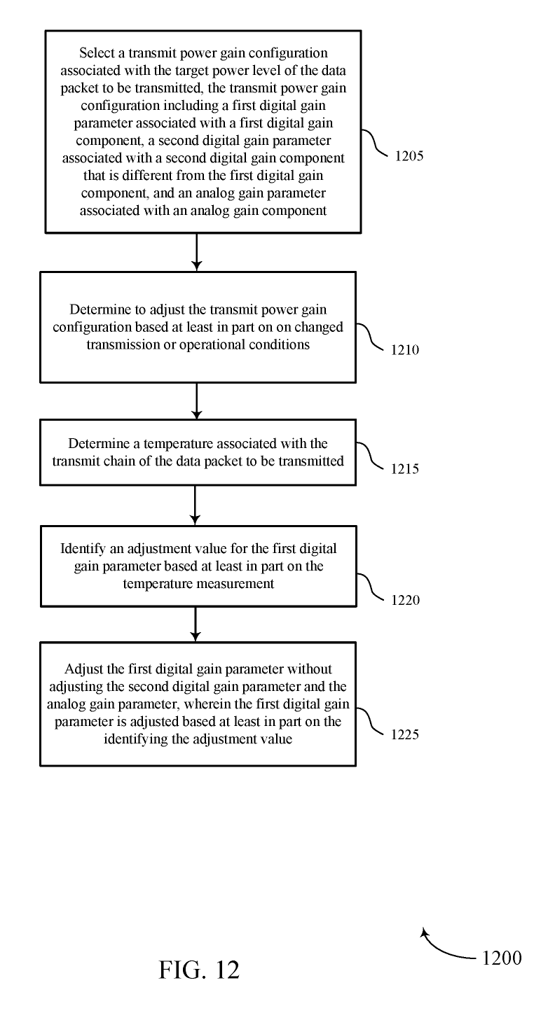

FIG. 12 shows a flowchart illustrating a method 1200 for providing transmit power gain calibration and compensation in accordance with various aspects of the present disclosure. The operations of method 1200 may be implemented by an AP 105 or its components as described herein. In other examples, the operations of method 1200 may be implemented by a STA 115 or its components as described herein. For example, the operations of method 1200 may be performed by a transmit power gain manager as described with reference to FIGS. 4 through 7. In some examples, an AP 105 may execute a set of codes to control the functional elements of the device to perform the functions described below. Additionally or alternatively, the AP 105 may perform aspects the functions described below using special-purpose hardware.

At block 1205 the AP 105 may select a transmit power gain configuration associated with a target power level of a data packet to be transmitted, the transmit power gain configuration including a first digital gain parameter associated with a first digital gain component, a second digital gain parameter associated a second digital gain component that is different from the first digital gain component, and an analog gain parameter associated with an analog gain component. The operations of block 1205 may be performed according to the techniques described with reference to FIGS. 1 through 3. In certain examples, aspects of the operations of block 1205 may be performed by a transmit power selection component as described with reference to FIGS. 4 through 7.

At block 1210 the AP 105 may determine to adjust the transmit power gain configuration based at least in part on changed transmission or operational conditions (e.g., a type of the data packet to be transmitted, a type of transmission associated with the data packet to be transmitted, or a temperature measurement). The operations of block 1210 may be performed according to the techniques described with reference to FIGS. 1 through 3. In certain examples, aspects of the operations of block 1210 may be performed by a transmit power adjustment determination component as described with reference to FIGS. 4 through 7.

At block 1215 the AP 105 may determine a temperature associated with the transmit chain of the data packet to be transmitted. The operations of block 1215 may be performed according to the techniques described with reference to FIGS. 1 through 3. In certain examples, aspects of the operations of block 1215 may be performed by a temperature sensor component as described with reference to FIGS. 4 through 7.

At block 1220 the AP 105 may identify an adjustment value for the first digital gain parameter based at least in part on the temperature. The operations of block 1220 may be performed according to the techniques described with reference to FIGS. 1 through 3. In certain examples, aspects of the operations of block 1220 may be performed by a gain adjustment component as described with reference to FIGS. 4 through 7.

At block 1225 the AP 105 may adjust the first digital gain parameter without adjusting the second digital gain parameter and the analog gain parameter. The first digital gain parameter may be adjusted based at least in part on the identifying the adjustment value. The operations of block 1215 may be performed according to the techniques described with reference to FIGS. 1 through 3. In certain examples, aspects of the operations of block 1215 may be performed by a gain adjustment component as described with reference to FIGS. 4 through 7.

In this regard, the AP 105 can modify one or more gain parameters based at least in part on expected transmit power gain changes corresponding to temperature changes associated with its transmit chip and/or board components in accordance with some implementations. The adjustment values identified at block 1220 by the AP 105 for which the AP 105 can use to modify one or more gain parameters may be based at least in part on factory testing results, empirical data, or the like and without transmission of short calibration packets.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system (e.g., wireless network 100 of FIG. 1)—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, in a system comprising:
a processor;
memory in electronic communication with the processor; and
instructions stored in the memory and operable, when executed by the processor, to cause the apparatus to:
transmit a first calibration packet at a first power level, the transmitting based at least in part on a first transmit power gain index associated with the first power level;
determine a power measurement corresponding to the first calibration packet based at least in part feedback associated with a transmit power output of the first calibration packet;
compare the power measurement corresponding to the first calibration packet to a target power level associated with the first power level; and
adjust one or more gain parameters associated with the first power level based at least in part on the comparing.

2. The apparatus of claim 1, wherein the instructions to cause the apparatus to adjust one or more gain parameters cause the apparatus to:
adjust one or more digital gain parameters associated with the first transmit power gain index.

3. The apparatus of claim 1, wherein the instructions to cause the apparatus to adjust one or more gain parameters cause the apparatus to:
select a set of digital and analog gain parameters associated with a second transmit power gain index, the second transmit power gain index different from the first transmit power gain index.

4. The apparatus of claim 1, wherein the instructions are further operable to cause the processor to:
delay a transmission of a queued data packet until determining the power measurement corresponding to the first calibration packet, the queued data packet being associated with a pending transmission to be transmitted at the first power level.

5. The apparatus of claim 1, wherein the first calibration packet comprises an indication that distinguishes the first calibration packet from a data packet, and wherein the first calibration packet is shorter than a first scheduled data packet for transmission prior to the first calibration packet and is shorter than a second scheduled data packet for transmission after the first calibration packet.

6. The apparatus of claim 1, wherein the instructions to cause the apparatus to transmit a first calibration packet cause the apparatus to:
transmit the first calibration packet based at least in part on an indication of a first temperature change.

7. The apparatus of claim 6, wherein the instructions are further operable to cause the apparatus to:
perform a transmit power gain calibration procedure based at least in part on an indication of a second temperature change, the second temperature change being different from the first temperature change.

8. The apparatus of claim 1, wherein the instructions are further operable to cause the apparatus to:
apply the one or more gain parameters associated with the first power level to a first transmit chain; and
transmit a first data packet via the first transmit chain.

9. The apparatus of claim 8, wherein the instructions to cause the apparatus to transmit a first calibration packet cause the apparatus to transmit the first calibration packet at a first frequency range and the instructions are further operable to cause the apparatus to:
transmit a second calibration packet at the first power level and at a second frequency range that is different from the first frequency range, the transmitting based at least in part on the first transmit power gain index associated with the first power level.

10. The apparatus of claim 9, wherein the instructions are further operable to cause the apparatus to:
determine a power measurement corresponding to the second calibration packet based at least in part on feedback associated with a transmit power output of the second calibration packet;
compare the power measurement corresponding to the second calibration packet to the target power level associated with the first power level; and
adjust the one or more gain parameters associated with the first power level based at least in part on the comparing the power measurement corresponding to the second calibration packet to the target power level.

11. The apparatus of claim 10, wherein the instructions are further operable to cause the apparatus to:
apply the one or more gain parameters associated with the first power level to a second transmit chain; and
transmit a second data packet via the second transmit chain.

12. The apparatus of claim 1, wherein the one or more gain parameters are associated with a transmit power gain index and a temperature at which the transmit power gain index was calibrated.

13. A method for wireless communication, comprising:
transmitting a first calibration packet at a first power level, the first calibration packet comprising an indication that distinguishes the first calibration packet from a data packet;
determining a power measurement associated with the first calibration packet based at least in part on a transmit power output of the first calibration packet measured by a first transmit feedback circuit path;
comparing the power measurement corresponding to the first calibration packet to a target power level associated with the first power level; and
adjusting one or more gain parameters associated with the first power level based at least in part on the comparing.

14. The method of claim 13, wherein the adjusting one or more gain parameters comprises:
adjusting one or more digital gain parameters associated with the first transmit power gain index.

15. The method of claim 13, wherein the adjusting one or more gain parameters comprises:
selecting a set of digital and analog gain parameters associated with a second transmit power gain index, the second transmit power gain index different from the first transmit power gain index.

16. The method of claim 13, further comprising:
delaying a transmission of a queued data packet until determining the power measurement associated with the first calibration packet, the queued data packet being associated with a pending transmission to be transmitted at the first power level.

17. The method of claim 13, wherein the first calibration packet comprises an indication that distinguishes the first calibration packet from a data packet, and wherein the first calibration packet is shorter than a first scheduled data packet for transmission prior to the first calibration packet and is shorter than a second scheduled data packet for transmission after the first calibration packet.

18. An apparatus for wireless communication, comprising:
a processor;
memory in electronic communication with the processor; and
instructions stored in the memory and operable, when executed by the processor, to cause the apparatus to:
select a transmit power gain configuration associated with a target power level of a data packet to be transmitted, the transmit power gain configuration including a first digital gain parameter associated with a first digital gain component, a second digital gain parameter associated with a second digital gain component that is different from the first digital gain component, and an analog gain parameter associated with an analog gain component;
determine to adjust the transmit power gain configuration based at least in part on changed transmission or operational conditions; and
adjust the first digital gain parameter without adjusting the second digital gain parameter and the analog gain parameter.

19. The apparatus of claim 18, wherein the instructions are further operable to cause the apparatus to:
detect a calibration packet among a plurality of data packets;
measure a transmit power level associated with the calibration packet; and
compare the measured transmit power level with the target power level, and
wherein the first digital gain parameter is adjusted based at least in part on the comparing.

20. The apparatus of claim 18, wherein the instructions are further operable to cause the apparatus to:
determine a temperature associated with the transmit chain of the data packet to be transmitted; and
identify an adjustment value for the first digital gain parameter based at least in part on the temperature, and
wherein the first digital gain parameter is adjusted based at least in part on the identifying.
